(19) United States
(12) Patent Application Publication
(10) Pub. No.: US 2022/0068154 A1
(43) Pub. Date: Mar. 3, 2022

(54) Secure Testing Device with Combiner

(71) Applicant: Intelligent Technologies International, Inc., Miami Beach, FL (US)

(72) Inventors: David S. Breed, Miami Beach, FL (US); Wilbur E. DuVall, Katy, TX (US); Serhii Shostak, Kyiv (UA); Oleksandr Shostak, Kyiv (UA); Vyacheslav Sokurenko, Kyiv (UA); Aron Sereny, Tarrytown, NY (US)

(73) Assignee: Intelligent Technologies International, Inc., Miami Beach, FL (US)

(21) Appl. No.: 17/467,335

(22) Filed: Sep. 6, 2021

Related U.S. Application Data
(63) Continuation-in-part of application No. 16/717,020, filed on Dec. 17, 2019, now abandoned.
Application No. 16/717,020 is a continuation-in-part of application No. 16/564,905, filed on Sep. 9, 2019, now abandoned.
Application No. 16/564,905 is a continuation-in-part of application No. 16/107,164, filed on Aug. 21, 2018, now Pat. No. 10,410,535.
Application No. 16/107,164 is a continuation-in-part of application No. 15/964,208, filed on Apr. 27, 2018, now abandoned.
Application No. 15/964,208 is a continuation of application No. 15/329,243, filed on Jan. 25, 2017, now Pat. No. 9,959,777.
(60) Provisional application No. 62/668,965, filed on May 9, 2018.
(60) Provisional application No. 62/644,897, filed on Mar. 19, 2018.
(60) Provisional application No. 62/040,806, filed on Aug. 22, 2014.

(51) Int. Cl. G09B 7/07; G02B 27/01; G10L 17/00; G06K 9/00; H04N 5/247

(52) U.S. Cl. CPC G09B 7/07; G02B 27/0176; G02B 27/0172; G10L 17/00; G02B 2027/014; G06K 9/00617; H04N 5/247; G02B 2027/0178; G02B 2027/0138; G06K 9/00604

(57) ABSTRACT

System for use in testing includes a frame positionable on a person's head, a display section, and a combiner arranged at least partly in front of the eyes of the person and which allows simultaneous viewing of an environment in front of the person and content on the display section, e.g., test questions. A crossview camera system images from locations on each lateral side of the frame toward the opposite lateral side and below the combiner. An iris camera system images the eyes of the person. A forward-looking camera system images an area in front of the frame. A processor analyze images obtained by the crossview camera system to determine presence of imaging devices, images obtained by the iris camera system to determine position of irises of the person and optionally imaging devices, and images obtained by the forward-looking camera system to determine presence of specific objects.

### FIELD OF THE INVENTION

The present invention relates generally to the field of a computer-based system and method for taking a test while ensuring that the test-taker is not receiving assistance from another person or otherwise cheating while taking the test, and that a device used for displaying or taking the test has not been breached and is not being breached or otherwise compromised.

### BACKGROUND OF THE INVENTION

There is significant discussion over the past several years relating to MOOCs, Massive Open Online Courses. Using the Internet, education can be freely distributed to anyone who has Internet access. Mastery of almost any field taught in colleges and universities can be achieved by a motivated student without attending lectures at that college or university. Thus, technology is in place for a student to obtain, at virtually no cost, knowledge that has previously only been available to a campus-resident, matriculated student at a college, university or other institution.

In contrast, the cost of a traditional Massachusetts Institute of Technology (MIT) education, for example, resulting in a bachelor's degree can approach or exceed $200,000. The only impediment which exists from preventing a university such as MIT from granting a degree to an online-taught student is that the university needs to know with absolute certainty that the student did not cheat when taking various examinations required to demonstrate mastery of the coursework. With a degree from MIT, for example, industry will hire such a person at a starting salary approaching or exceeding $100,000 per year. Thus, the value to the student is enormous. Since the information which must be mastered is now available for free on the Internet, the main impediment separating a motivated and capable student from a high starting salary is that a degree-granting university must be certain that the student has demonstrated mastery of the material through successful completion of examinations without the assistance of a helper or consultant while taking the examinations.

Even when examinations are administered in a classroom, it is well known that extensive cheating can occur. In China, for example, where admission to college is solely determined by the score that a student receives on a one-time examination, motivation to cheat is enormous.

U.S. Pat. No. 5,565,316 (Kershaw et al.) describes a system and method for computer-based testing. A test development system produces a computerized test, and a test delivery system delivers the computerized test to an examinee's workstation. The method comprises producing a computerized test, delivering the computerized test to an examinee and recording examinee responses to questions presented to the examinee during the delivery of the computerized test. A method of delivering a computerized test is also provided in which a standardized test is created, an electronic form of the test is then prepared, the items of the test are presented to an examinee on a workstation display and the examinee's responses are accepted and recorded. A method of administering a computerized test is further provided in which a computerized test is installed on a workstation and then the delivery of the test to an examinee is initiated.

U.S. Pat. No. 5,915,973 (Hoehn-Saric et al.) describes a system for controlling administration of remotely proctored, secure examinations at a remote test station, and a method for administering examinations. The system includes a central station, a registration station and a remote test station. The central station includes (a) a storage device for storing data, including test question data and verified biometric data, and (b) a data processor, operably connected to the storage device, for comparing test-taker biometric data with stored, verified biometric data. The remote test station includes (a) a data processor, (b) a data storage device, operably connected to the data processor, for storing input data, (c) a biometric measurement device for inputting test-taker biometric data to the data processor, (d) a display for displaying test question data, (e) an input for inputting test response data to the data processor, (f) a recorder for recording proctoring data of a testing event, and (g) a communication link for communicating with the central station, for receiving test question data from the central station, and for communicating test-taker biometric data, test response data, and proctoring data to the central station. Verification of the test-taker and validation of the results are performed before or after the testing event.

U.S. Pat. No. 5,947,747 (Walker et al.) describes methods and apparatus for computer-based evaluation of a test-taker's performance with respect to selected comparative norms. The system includes a home testing computer for transmitting the test-taker's test results to a central computer which derives a performance assessment of the test-taker. The performance assessment can be standardized or customized, as well as relative or absolute. The transmitted test results reliably associate the test-taker with his test results, using encoding, user identification, or corroborative techniques to deter fraud. For example, the system allows a parentally-controlled reward system such that children who reach specified objectives can claim an award that parents are confident was fairly and honestly earned without the parent being required to proctor the testing. Fraud, and the need for proctoring, is also deterred during multiple test-takers testing via an option for simultaneous testing of geographically dispersed test-takers.

U.S. Pat. No. 7,069,586 (Winneg et al.) describes a method and system for securely executing an application on a computer system such that a user cannot access or view unauthorized content available on or accessible using the computer system. To securely execute the application, such method and system may terminate any unauthorized processes executing (i.e., running) on the computer system application prior to execution of the application, and may configure the application such that unauthorized content cannot be accessed, including configuring the application such that unauthorized processes cannot be initiated (i.e., launched) by the application. Further, such system and method terminates any unauthorized processes detected during execution of the application and disables any functions of the computer system that can access unauthorized content, including disabling any functions capable of initiating processes on the computer system. The application being securely executed may be any of a variety of types of applications, for example, an application for receiving answers to questions of an examination (i.e., an exam-taking application). Securely executing an application may be used for purposes, including to assist preventing test-takers from cheating on exams, to assist preventing test-takers from not paying attention in class, to assist preventing employees from wasting time at work, and to assist preventing children from viewing content that their parents deem inappropriate.

U.S. Pat. No. 7,257,557 (Hulick) describes a method, program and system for administering tests in a distributed data processing network in which predetermined test content and multimedia support material are combined into a single encrypted test file. The multimedia support may include visual and audio files for presenting test questions. The encrypted test file is exported to at least one remote test location. The test locations import and decrypt the encrypted test file and load the test content and multimedia support material into a local database. The test is administered on client workstations at the testing location, wherein the test may include audio questions and verbal responses by participants. During testing, biometric data about test participants is recorded and associated with the test files and participant identification. After the test is completed, the completed test results, including verbal responses and biometric data, are combined into a single encrypted results file exported to a remote evaluation location. The evaluation location imports and decrypts the encrypted results file and loads the test results into a local database for grading.

U.S. Pat. Appln. Publ. No. 2007/0117083 (Winneg et al.) describes systems, methods and apparatus for remotely monitoring examinations. Examinations are authored and rules are attributed to the exams that determine how the exams are to be administered. Proctors monitor exam takers from remote locations by receiving data indicative of the environment in which the exam takers are completing the exams. A remote exam monitoring device captures video, audio and/or authentication data and transmits the data to a remote proctor and data analysis system.

Despite these and other patents and applications that describe methods of preventing cheating on examinations, a Google search reveals that cheating on examinations is prevalent worldwide. In fact, companies now advertise that they will take a test for you and even name famous proctoring companies that they can defeat. Thus, these inventions, if implemented, have not been successful in eliminating cheating on examinations. For example, recently students taking examinations for credit in connection with MOOCs have found that they can register many times for a course, and collect and combine the results of multiple simultaneous examinations to compose a single correctly answered test for submission for credit. This is known as Cameo cheating.

The following companies provide proctor services during exam/tests:

ProctorU

https://www.proctoru.com/

Kryterion—acquired by Pearson in 2015

https://www.onlineproctoring.com/

Examity

http://examity.com/

Pearson Vue—both online proctored test and a network of physical test centers

https://home.pearsonvue.com/

Proctorio

https://proctorio.com

B Virtual Inc.

https://bvirtualinc.com/

Question Mark Online Proctoring

https://www.questionmark.com/content/online-proctoring-service

Mercer Mettl

https://mettl.com

Honorlock

https://honorlock.com

Respondus

https://web.respondus.com

And many others for a total of at least 20 such companies.

These companies have a similar sequence of the services provided: proctor identifies test-taker person (using test-taker's passport or any other documents); proctor continues to observe the testing session (all sessions are usually video recorded, desktop of the test-taker computer will be also recorded), and proctor checks the test-taker during the test (it can be made in a way of questioning the test-taker or audio signals that ring at certain times).

According to the presentation of Kryterion company: “ . . . After the proctor verifies that your ID matches your image appearing on their web camera, they will ask you to answer a few security questions. These will further ensure that the correct person is taking the exam.”

So, basically, ‘cheating’ means receiving test answers while proctor observes the test-taker sitting in front of the computer into which the test answers are input.

Cheating essentially consists of two stages: interception of unique test questions and receiving answers to test questions. Receiving answers can be much easier for a cheating test-taker than intercepting information from a company that sent special tests to the examinee.

Online proctored testing (almost all the above-mentioned companies) allow test-takers to take and pass exams from their homes. This fact increases the possibility of cheating.

Receiving answers which won't be noticed by proctors can be done by the following ways: answers are provided on a tablet or a smartphone located behind (or near) the monitor; projection of the answers to any surface (wall, screen, etc.) behind the monitor as illustrated below (FIG. 1); using a compact Morse code transmitter by touching the skin of the test-taker; a micro-earpiece located in the ear, vibrations in the seat, a bone speaker attached to the test-taker's shoulder (or other bone) underneath clothes, etc.

Question interception can be achieved by hidden micro cameras (located in the wall or on the test-taker's clothes) which capture the monitor screen with answer choices and sends it to test-taker's consultant. Alternatively, it can be achieved by a transmitter which captures video signals from the system to the monitor, and located in conjunction with monitor wires, and then transmitted to the consultant.

To summarize, there are many ways that a consultant can obtain a copy of the questions on an exam and transmit the answers to the test taker that are not and cannot be detected by proctoring services.

As generally used herein, a “test” is any type of question-based application that requires consideration or analysis by a person taking the test and a potential response from this person. A test may therefore be considered an examination, a quiz, an assessment, an evaluation, a trial and/or an analysis. The test may be used to certify an individual as qualified to perform a specific task or ability, e.g., a driving test. A test-taker is a person taking such a test. A test-taker does not necessarily have to be a student of a course, i.e., someone subjected to education on a regular basis.

### OBJECTS AND SUMMARY OF THE INVENTION

The present invention is directed at addressing and ideally solving the problem of guaranteeing with high certainty that a test-taker taking a test is acting alone without the aid of a consultant or other helper or otherwise cheating.

A device that can achieve this object includes a frame configured to be situated on a person's head, a display section on the frame having a first portion and a second portion, and a combiner on the frame in a position at least partly in front of right and left eyes of the person when the frame is on the person's head. The combiner, an optic or optical element, allows simultaneous viewing by the person of an environment in front of the person and content on the display section. Thus, the combiner reflects content of the first portion of the display section to the person's left eye when the frame is on the person's head and reflecting content of the second portion of the display section to the person's right eye when the frame is on the person's head. A crossview camera system, possibly on the frame, images from a location on a first lateral side of the frame toward a second lateral side of the frame opposite the first lateral side and below the combiner, and images from a location on the second lateral side of the frame toward the first lateral side of the frame and below the combiner. An iris camera system, possibly on the frame, images the eyes of the person on which the frame is situated. A forward-looking camera system, possibly on the frame, images an area in front of the frame. A processor is coupled to the crossview camera system, the iris camera system and the forward-looking camera system and analyzes images obtained by the crossview camera system to determine presence of imaging devices in any obtained images, images obtained by the iris camera system to determine position of irises of the person on which the frame is situated, and images obtained by the forward-looking camera system to determine presence of specific objects that aid in cheating hereinafter referred to as cheat-aiding objects (which are known or of a type known to those skilled in the art to which this invention pertains).

The crossview camera system may include a first crossview camera on the first lateral side of the frame and that images inward of the first lateral side of the frame and below the combiner, and a second crossview camera on the second lateral side of the frame and that images inward of the second lateral side of the frame and below the combiner. The iris camera system may include a first iris camera that images the left eye of the person on which the frame is situated, and a second iris camera that images the right eye of the person. The first and second portions of the display section may be positioned horizontally alongside one another

The combiner optionally includes a semi-reflective coating on an inside surface in an optical path between the first and second portions of the display section and the person's eyes when the frame is on the person's head. The combiner is positioned in front of the person's eyes when the frame is on the person's head to allow viewing of the ambient environment in front of the person when the frame is on the person's head. Also, the combiner could include an antireflective coating on an outside surface to allow maximum light to pass through the combiner from the environment.

The processor may be trained, programmed or otherwise configured to analyze images obtained by the iris camera system and perform a biometric identification, based on the image analysis and previously obtained biometric data. Similarly, the processor may be trained, programmed or otherwise configured to analyze images obtained by the iris camera system to determine presence of imaging devices in any obtained images. To this end, the processor could use pattern recognition when analyzing images obtained by the crossview camera system to determine presence of imaging devices in any obtained images, when analyzing images obtained by the iris camera system to determine position of irises of the person on which the frame is situated, and/or when analyzing images obtained by the forward-looking camera system to determine presence of specific objects.

A forehead resting pad may be arranged at a front of the frame in a position to contact a forehead of the person when the frame is on the person's head. The frame may be considered to include a front portion including the display section, the combiner, the crossview camera system, the iris camera system, the forward-looking camera system, and the processor, and a first elongate band having first and second opposite ends and being coupled at the first and second ends to the front portion. The frame includes a second elongate band adjacent the front portion and which is in contact with skin of the person when the frame is on the person's head, the second band including a contact microphone and a contact speaker. A chassis intrusion detector system may be arranged over the front portion of any embodiment.

Another embodiment of a device includes a housing comprising a display section including at least one display for displaying content, an optical element coupled to the housing and arranged in an optical path of the at least one display section and that reflects at least a portion of content when displayed on the at least one display and allows viewing therethrough, a crossview camera system coupled to the housing and that images from locations on each lateral side of the housing toward an opposite lateral side of the housing portion and below the optical element, an iris camera system coupled to the housing and that images an area rearward of the housing from locations on the housing rearward, and a forward-looking camera system coupled to the housing and that images an area in front of the housing from locations on the housing. A processor is arranged in the housing and coupled to the crossview camera system, the iris camera system and the forward-looking camera system. The processor analyzes images obtained by the crossview camera system to determine presence of imaging devices in any obtained images, images obtained by the iris camera system to determine presence and position of irises, and images obtained by the forward-looking camera system to determine presence of specific objects. A first elongate band has first and second opposite ends and is coupled at the first and second ends to the housing. The first band extends rearward from the housing to form an enclosure in which a person's head is positionable.

The crossview camera system may include a first crossview camera on the first lateral side of the housing and arranged to image inward of the first lateral side of the housing and below the combiner, and a second crossview camera on the second lateral side of the housing and arranged to image inward of the second lateral side of the housing and below the combiner. The combiner may include a semi-reflective coating on an inside surface in the optical path of the at least one display section, and an antireflective coating on an outside surface to allow maximum light to pass through the combiner from the environment. The at least one display section may include two display sections positioned horizontally alongside one another.

The processor optionally, but preferably, analyzes images obtained by the iris camera system to determine presence of imaging devices in any obtained images. Also, the processor could use pattern recognition when analyzing images obtained by the crossview camera system to determine presence of imaging devices in any obtained images, when analyzing images obtained by the iris camera system to determine presence and position of irises, and when analyzing images obtained by the forward-looking camera system to determine presence of specific objects.

The device could include a forehead resting pad arranged at a front of the housing, a second elongate band adjacent the housing and including a contact microphone and a contact speaker, and a chassis intrusion detector system arranged over the housing.

Another embodiment of the invention is directed to an arrangement for test-taking includes a head-wearable device which includes at least one sound or vibration sensor for detecting sound or vibration, at least one optical imaging device that obtains images of an area viewed by the test-taker, at least one optical imaging device that obtains images of the iris, retina, or face portion, and a display which is only viewable by the test-taker. Hereinafter, the term iris camera will mean any imaging device which images the iris, a portion of the face around and including the iris, retina, a portion of the face around and including the retina, or face portion optionally including the iris and/or retina. The display can be a light emitting display such as an LED, LCOS or OLED, QLED, MicroLED, a light reflective display or a retinal projector display. A processing unit is coupled to the sensor(s) and imaging device(s) and receives and analyzes data therefrom to determine whether the test-taker is interacting with another person, including whether the test-taker is communicating with another person. The processing unit which analyzes the images from the various cameras may reside on a server of coupled computer such as a smartphone. The processing unit also decrypts tests questions sent to it for display on the display.

A headpiece or monitor in accordance with the invention includes a frame having a support portion adapted to be supported on a test-taker's head and a viewable portion adapted to present visual data to the test-taker when the support portion is supported on the test-taker's head. This headpiece may be of the type like, for example, Google Glass™ or Hololens™. A self-contained electronics assembly includes at least one imaging device and a display and is arranged on a frame like a glasses frame and obtains images of the environment in front of the test-taker when worn on the test-taker's head. A processor is arranged within the self-contained electronics assembly mounted on the frame and can be coupled to a remote server and/or a computing device such as a smartphone, personal computer, laptop or tablet. The processor is configured to control content of the viewable portion based on input received from the remote server or connected computing device. At least one audio or contact microphone is integral with the electronics assembly which detects audio or vibrational communications or talking or other sound emission by the test-taker. The processor monitors detection of sound by the microphone(s) and images obtained by the imaging device(s) when the viewable portion is displaying a test to determine whether a person other than the test-taker is present or providing information to the test-taker or that the test-taker is talking or making other sounds. The contact microphone may be used as a user interface in which case the processor monitors detection of sound or vibration by the contact microphone when the viewable portion is displaying a test, or at other times.

A method for detecting an attempt to physically gain access to or alter the electronics assembly in accordance with the invention is a type of chassis intrusion detector. In the method, the device is enclosed by a film onto which is deposited a labyrinth of conductive wires comprising a continuous circuit. The resistance, capacitance and/or inductance of the circuit is monitored for a break in the circuit which would correlate with (be considered) any attempt to breach the electronics and sensor assembly.

The security assembly can include a processor, a power source for providing power to the processor and a volatile RAM assembly containing private executable code or information such as a required security code, or private key, or other private information or code for use of the device for test-taking purposes. The security assembly is configured such that any attempt to disassemble the security assembly will break one or more wires connecting the power source to the RAM or cause a change in capacitance, resistance and/or inductance relative to a threshold which will cause the private information to be erased from the RAM assembly. The security assembly is coupled to the electronics assembly which, with the security assembly, resides within the space enclosed by the film with the wire labyrinth. An aperture is provided in the envelope defined by the wire labyrinth in which the electronics assembly is placed, the aperture permitting a wire to connect the electronics assembly to a source of power, an external server or computing device or the Internet. The wire labyrinth is sufficiently transparent as to permit the camera(s) to obtain images there through and permit viewing of the display by the test-taker.

An intrusion-protected electronic device in accordance with the invention includes an envelope defined by a wire labyrinth, that encloses the electronics assembly including the security assembly coupled to the film and that periodically measures the capacitance, resistance and/or inductance of the wire labyrinth. The security assembly is configured to monitor the measured capacitance, resistance and/or inductance to determine changes in one of these properties, changes in any of these properties being correlated with an attempt to breach or alter the device.

Additional devices which can be part of the electronics assembly and which are designed to operate through the security film include:
1. A camera for obtaining iris, retinal or partial facial scans.
2. A microphone for monitoring sound in the vicinity of the test-taker or emitted by the test-taker.
3. A sound maker used for testing the microphone sensitivity.
4. A camera for monitoring the area between the display and the test-taker's eyes.
5. A contact microphone for detecting sound emanating from the mouth of the test-taker, primarily talking, i.e., words.
6. A contact speaker for testing that the contact microphone is in contact with the test-taker's skin.
7. A device mounted in connection with the contact microphone for detecting the presence of the test-taker's skin. Such a device can comprise a blood flow sensor comprising a LED and light sensor positioned so that the reflection of the LED is in the field of view of the light sensor only when the device is in close proximity to the skin. Skin presence sensors can also comprise a temperature sensor, camera, capacitance sensor or any other device capable of determining the presence of the test taker's skin.
8. Two or more ECG (EKG) pads for detecting and recording the electrocardiogram of the test-taker.
9. A mouse and/or a keyboard for providing input to the processor.

### BRIEF DESCRIPTION OF THE DRAWINGS

The following drawings are illustrative of embodiments of the system developed or adapted using the teachings of at least one of the embodiments disclosed herein and are not meant to limit the scope of the disclosure as encompassed by the claims.

FIG. 1 illustrates some possible cheating methods used by test-taker.

FIGS. 2 and 3 show forward and back views of a monitor device of the invention.

FIGS. 4 and 5 illustrate cutaway views of a monitor of the invention.

FIG. 6 is a chassis intrusion detector design and its assembly sequence.

FIG. 7 shows the unassembled monitor housing.

FIG. 8 shows the chassis intrusion detector operating principle.

FIGS. 9 and 10 illustrate a monitor device when worn by a person.

FIG. 11 illustrates a monitor block diagram.

FIG. 12 illustrates a system block diagram.

FIG. 13 illustrates a representative administrative sequence.

FIG. 14 illustrates a representative test-taking sequence.

FIG. 15 illustrates a representative biometric block diagram.

FIG. 16 illustrates a monitor connected to a power and Wi-Fi module which plugs into wall.

FIG. 17 illustrates a situation where the monitor plugs into a smartphone.

FIG. 18 shows the monitor with associated mouse and keyboard.

FIG. 19 illustrates an optics detail showing one method of nearsightedness and farsightedness adjustment and nose rest adjustment.

FIG. 20 is a 3D-diagram of the display and iris-scanner module.

FIG. 21 illustrates the ray path in the display channel.

FIG. 22 shows the ray path for the iris-scan camera.

FIG. 23 is a lens prescription data.

FIG. 24 shows an alternative type of monitor frame.

FIGS. 25 and 26 show devices based on standard glasses with one lens remaining.

FIGS. 27, 28, 29 and 30 illustrate another preferred version of the monitor.

FIG. 31 illustrates a method of attaching a USB connector for supplying power to the monitor through the CID.

FIGS. 32 and 33 illustrate use of a contact speaker with a contact microphone to verify that the contact speaker contacts the test-taker's face and further, use of an EKG biometric for additional verification of proper placement of the contact microphone and to obtain an additional biometric.

FIGS. 34 and 35 illustrate methods of cheating proctored exams.

FIG. 36 illustrates the use of the apparatus in accordance with the invention by a room full of test-takers where each device is attached to a central computer through a USB port.

FIG. 37 is a view like FIG. 36 with a wireless connection through a wireless transmitter box associated with each desk and where the test-takers are using paper to record their test answers.

FIG. 38A is a perspective view of a head worn glasses type device containing an electronics assembly with several sensors, cameras and a display all protected with a chassis intrusion detector prepared using the teachings of this disclosure.

FIG. 38B is a perspective view of the apparatus of FIG. 38A seen from the rear.

FIG. 39 illustrates the existence of a call center composed on test monitors and another of test taker helpers assisting cheaters.

FIGS. 40A and 40B illustrate a preferred design of a monitor using a reflection display.

FIG. 41 illustrates a preferred design of a monitor using a waveguide display.

FIGS. 42A, 42B, 42C and 42D illustrate Common optical designs for see-through near-eye displays.

FIGS. 43A, 43B, 43C, 43D, 43E and 43F illustrate a preferred design of the monitor for two eyes utilizing a single display.

FIGS. 44A, 44B, 44C, 44D, 44E, 44F, 44G, 44H and 44I illustrate a preferred design of the monitor for two eyes utilizing a two large displays.

FIGS. 45A, 45B, 45C and 45D illustrate the device of FIGS. 44A-44I with the chassis intrusion detector installed.

### DETAILED DESCRIPTION OF THE INVENTION

1. Administration and System Operation

A primary concept of the present invention is that a student located anywhere in the world ought to be able to obtain a degree from any college or university, provided the student can prove that he or she has mastered the coursework. Proof often comes from the student passing a series of examinations. Since the student can be located anywhere in the world, it can be impractical for that student to travel to a particular place in order to take an examination.

A secondary concept of the present disclosure is to permit a classroom full of students to take a test without cheating. Consider for example, the test required for college entrance. Normally, the SAT must be taken at an approved location where the test taking can be monitored by proctors. Cheating can still occur in that situation as has been vividly pointed out in recent cheating exposés which have dominated the news in 2019, where proctors gave out the test questions prior to the exam in one case and altered the exam answers in other cases. Using the system described herein, an SAT or GRE can be taken anyplace without concern that the test-taker may be cheating. Thus, a test-taker does not need to travel to an approved location, but can take the SAT from his home, or other convenient location, which can be anywhere in the world. Additionally, many colleges and universities as well as US-based companies require foreign born applicants to pass an English proficiency test, the TOEFL. In order to minimize the cost of taking such a test, a student or other person can take this test anywhere with the full assurance that he or she did not cheat.

Hiring organizations do not always care where the person has acquired the expertise if they can be confident that the student has done so. As an employer, for example, a manager does not care as much whether a person graduated from Harvard or MIT as he/she does whether the prospective employee has mastered the coursework. On the other hand, having a degree listed on a person's resume can greatly affect the person's opportunities for employment throughout his or her lifetime. In the US, however, colleges and universities have become unreasonably expensive, especially when consideration is given to the fact that for the most prestigious schools, the student usually is required to reside on or near the campus. This residency requirement has little to do with his or her mastery of physics, engineering or other scientific or non-scientific subjects, but handicaps an otherwise qualified student from job opportunities and lifetime earnings.

A student can typically learn the coursework on his or her own and in fact, studies have shown that for many students attending class is largely a waste of time. Over the Internet, a student can be exposed to the very best teachers providing well constituted lectures, textbooks and other coursework. If this is done with many students, the cost per student is minimal. What is needed, however, is a method of verifying that a student has mastered the subject matter through taking and passing examinations over the Internet or in a classroom, and without cheating and at minimal cost to the institution.

A further advantage of the secure test system described herein is that it permits the standardization of courses and tests. Thus, a student who chooses such standardized courses can study those courses from any college or university that meets the standard. A particular course, for example, may not be offered from a particular university during a particular semester and thus the student would be free to take that equivalent course from another college or university and since the tests would be standardized, the credits can be honored by any university where the student eventually wishes to obtained his or her degree. Thus, degrees become more portable and their acquisition more suitable to people who may live at various locations during the time of the college or university experience.

An objective of the present invention is therefore to provide a system that can ascertain the identity of a test-taker with certainty and that cheating has not occurred during test-taking. Prior to discussing how these goals are achieved, an understanding of the cheating prevention process needs to begin with an analysis of the flow of information from the test-providing institution to the test-taker's eyes.

For now, assume that the test is a multiple-choice test or one where the answer is in the form of a number. The institution can randomize the questions and answers of a test so that no test-taker will take the same test with the same order of questions or answers. Therefore, knowing the answers provided by one test-taker cannot help another test-taker. As a result, the answers which are sent back to the test-provider do not need to be encrypted, except where added security is desired that the answers have not been altered by the test providing company or the college or university as explained below.

The questions making up the test however do need to be encrypted and careful attention needs to be paid to where the decryption process occurs and to the protection of the private key which performs the decryption and the process by which it is generated. For example, if the decryption occurs in an unprotected computer, then two problems arise. First, the decrypted test can be captured, and a copy sent to a computer in another room, for example, or the private key can be copied, and a second computer can simultaneously decrypt the test. Once the test can be viewed by a consultant who is not seen by a proctoring system, the consultant can transmit answers to the test-taker by a countless number of methods facilitating cheating.

Consider how the consultant might conduct this transmission to the test-taker. Perhaps, the consultant is in an adjoining room and transmits answers using RF communication to a device hidden on the body of the test-taker which retransmits to a receiver pressed against a part of the test-taker's shoulder or head, hidden by his or her hair or clothing, or mounted on his or her teeth. Such devices are readily available. RF frequencies used can be chosen to be undetectable by any device designed to detect such transmissions since the range of frequencies available span more than 6 orders of magnitude and, in addition, frequency hopping techniques can be used. An RF sensor mounted anywhere cannot pick up such transmissions without knowing the transmitted frequency and coding scheme.

Even if the consultant is in another country, if he or she can see the test, there is no way to prevent transmission of answers to the test-taker. Other methods include vibrators in the seat, wires attached to head-mounted speakers, etc. The consultant can even project the answers onto a portion of the room ceiling, walls or floor which is not covered by room monitoring cameras but observable by the test-taker and can even alternate such locations to fool systems that monitor the test-taker's behavior. Basically, there is no method of preventing the consultant from communicating answers to the test-taker and therefore, it is necessary to prevent the consultant from obtaining the test questions.

If the questions are decrypted on an ordinary computer, then many potential information leakage problems exist. Regardless of the operating system, if the consultant can obtain access to the processor board of the computer, then the connector that connects to the display can be removed and reconnected to a splitter inserted in such a manner that the display operation is unaffected but a second set of wires are now available which contain the display information. These wires can be connected to a small processor which connects them to a transmitter to send the display information to another room by undetectable RE Alternately, a simple wire can be used, hidden from view of whatever monitoring cameras are present.

Another approach is to steal the private key which cannot be protected in an arbitrary computer. Once the consultant has the key, he or she can intercept the transmissions to the computer and decode the test in a second computer. A conclusion is that the private key, and/or the code used to generate the key, must be stored and the decryption process undertaken in a special protected device discussed below.

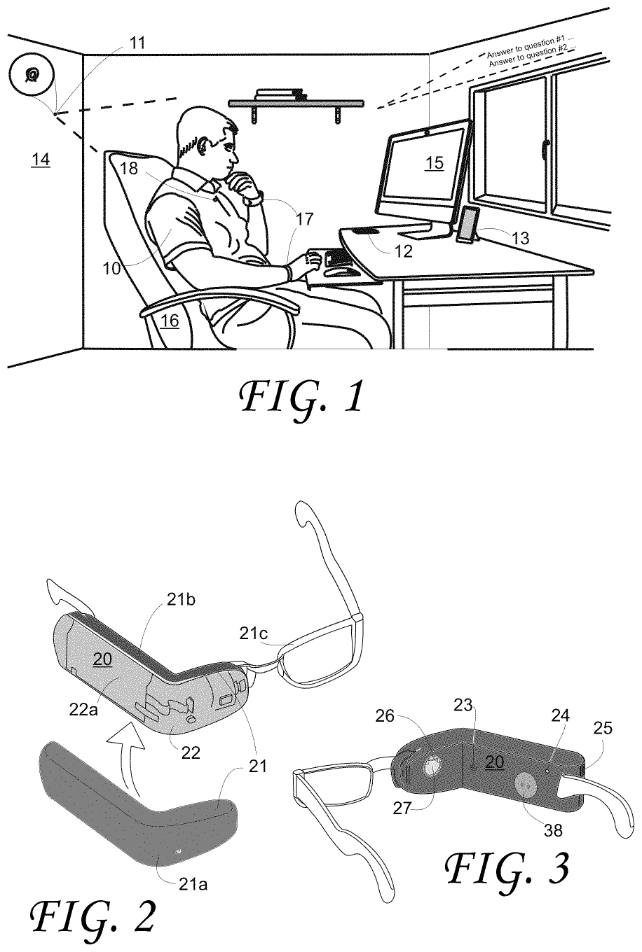

Consider now the display. If there is a display where the questions can be seen from anywhere other than the eyes of the test-taker, then there is another path for leakage of test questions. If decryption occurs right at the display and the display is protected from tampering, the display itself can facilitate transmission of the test questions. A camera looking through an undetectable port in a wall, see FIG. 1, or undetectably worn by the test-taker, can capture the image of the test questions and transmit this to a consultant by any number of methods. Thus, either the display must be scrambled, so that only the test-taker wearing special glasses can see the questions, or the display must be so close to the test-taker's eyes that no one else can get close enough to see it. The second of these approaches will be discussed below. A conclusion is that no ordinary display or ordinary computer is usable without incurring a risk of cheating.

Some methods for accomplishing the objective of cheating prevention which have been considered include using one or more cameras, even a 360 degree camera, to image a substantial portion of the space around the test-taker so that a consultant (or other person aiding the test-taker) cannot be located in a position where he or she can influence the test-taker without being seen by such a camera. A structure has been proposed such that the computer on which the test is being taken will not be accessible by another computer in another room, for example, where a consultant can simultaneously view the exam and communicate answers to the test-taker. If this structure is separated from the display and if the display is not scrambled or very close to the test-taker's eyes, this approach can be easily defeated. Also, it is not required that the consultant be where he or she can be observed by any cameras.

Similarly, it has been proposed that a microphone is preferably available to monitor the audio environment where test-taking is occurring to prevent audio communication with the test-taker by a consultant. A microphone will not pick up communications from the consultant in the form of RF communications translated into sound at the head, for example. The microphone will pick up any oral communications from the test-taker and thus it can be a necessary part of the system to detect if the test-taker is orally reading the questions to a consultant. To make sure that the microphone has been activated, a speaker or other sound source may be necessary to periodically create a sound which can be sensed by the microphone. Otherwise, the test-taker can cover the microphone or otherwise render it useless. An alternative or complementary approach, as described below, can make use of a contact microphone pressed against the skin or a facial bone, e.g., cheek bone, of the test-taker which will pick up sound emanating from the mouth of the test-taker but not be heard by the audio microphone. An audio microphone detects sound from the environment in addition to that from the test-taker. These sounds can drown out or otherwise prevent the microphone from picking up the test-taker from softly speaking into a hidden microphone that communicates with a remote consultant. These and other methods and apparatus are discussed below but already it has become evident that an apparatus used to take the test must be especially designed to solve the issues mentioned above.

The identity of the test-taker must be known and can be ascertained using one or more of a variety of biometric sensors and systems such as a palm, fingerprint, heartbeat shape, iris, retinal or other scan, a voiceprint, or a good image of the test-taker coupled with facial recognition as further discussed below. For the purposes of the present invention, the primary biometric identification system will rely on the use of a small camera which has been designed to periodically image the test-taker's iris, retina and/or portion of the test-taker's face as discussed below.

When taking a test, the test-taker can go through a process which sets up the apparatus and validates its operation. The test-taker can then confirm his identity which will have been previously established and stored locally or remotely for comparison. The process of ascertaining the identity can be recorded for later validation. Output from the various monitoring systems can be fed to one or more pattern recognition systems, such as trained neural networks, which can reside on a local or remote processor, which have demonstrated a high accuracy.

Each time the test-taker takes one or more tests and thus demonstrates his or her mastery of the coursework (by passing), he or she can be awarded credits and after enough credits have been obtained, he or she can be awarded a degree. After the degree award, the student would then presumably begin working for a company, government agency, or other organization and the system should periodically be verified through consultations or surveys with the management of the organization to ascertain that the hiring organization is satisfied with the proficiency of the student derived from the online courses. This feedback allows for continuous improvement of the overall educational and testing process and system.

The degree-granting institution will incur costs during this process and some payment from the student to the institution may be considered. Depending on the circumstances, this payment can be a charge per course, per test, or per degree. Since the earning power of the student can be significantly increased, and out-of-pocket cost to the institution is small, these payments can be postponed until the student is being paid by a hiring organization and, in fact, such an organization may be willing to cover these payments. In any event, the payment should be relatively small when compared to the typical cost of a traditional college education. However, the degree-granting institution by this method, can greatly expand the number of degrees granted and thus, although the payment per student will be small, the total sum earned by the institution can be substantial.

A good review of the state of higher education in the US and of the rise of MOOCs can be found in the Nicholas Carr's article on the subject as published in the MIT technology review. The article can be found on the following Internet website. http://www.technologyreview.com/featuredstory/429376/the-crisis-in-higher-education/. Quoting from this article “Machine learning may, for instance, pave the way for an automated system to detect cheating in online classes, a challenge that is becoming more pressing as universities consider granting certificates or even credits to students who complete MOOCs.” It is an objective of this invention to respond to the mentioned challenge.

As discussed in numerous places in the literature, there is a significant difference in the complexity of evaluating a student's proficiency through tests which can be machine graded depending on the course subject matter. For those math and science courses where a numerical answer is to be derived, machine evaluation of the test is relatively simple. However, for those disciplines where a reasoning or writing skill or an artistic or mechanical skill is evaluated, there is great controversy as to whether this can be done by machine testing. This issue will be addressed below although more research and innovation in this area is necessary.

It is not an objective of this invention to determine how a test should measure a student's proficiency nor how it should be graded. A primary objective here is to provide confidence to the degree-granting institution that the student who is taking a test is in fact the student who has registered for the course and that the student is acting alone without the aid of a consultant who may be remote or nearby. This assurance should be provided with a probability of cheating reduced to on the order of one in 100,000 and, similarly, the false accusation that cheating is taking place reduced to a similar probability.

When a student decides to enroll in a degree program, for example, or even to enroll in a course for which he or she desires credit, the first step will generally be to register with the organization, typically a college or university, and to establish the beginning of the student's record. During this registration process, for the case where the student intends to get credit for one or more courses taken online, the student will be required to submit various types of information which will permit the student to be identified positively over the Internet. Although there may be no charge for taking the course, there will generally be some charges related to the test-taking and administration of the student's program. In a preferred embodiment of this invention, a specially configured device will be rented, loaned or sold to the student to be used for test-taking.

When the student registers at a school, he or she will be generally required to submit a picture that will become part of his or her record. Later, when taking a test for the first time using the monitor (the generic name for the test-taking devices disclosed herein), another picture may be required so that the student can be properly associated with a public key, derived from his or her iris code, which can be part of his student ID. A second picture of the student may be required on registration while wearing the monitor. This is as a second check that the student in the school picture is the one wearing the monitor when the iris-based public key ID was created. In fact, to assure the maximum integrity, every person that registers with a college can be required to provide a picture which will be linked with his or her iris code and thus to his or her transcript. A student with the wrong iris code would then not have his transcript updated. Also, a prospective employer who receives a transcript also can get a picture which should match the person being hired. If the registration is done online, the laptop webcam can be used. If a student cheats by having a consultant take his or her tests, the transcript will not match the proper iris code and either the transcript will not be updated, or the transcript picture will not match the person.

Wearable glasses which meet one or more objects of this invention are described below and are configured so that all the functions necessary to identify the student and significantly reduce the opportunity for cheating are incorporated within the glasses design, hereinafter called the “Monitor”. At the end of the course, or when the student completes his relationship with the institution, he or she may be required to return the Monitor; however, since in some implementations the Monitor may be linked to the student's biometric-based identification, the biometrics stored on the device, if any, would need to be erased or overwritten by those of another student (described below). In one method, a cryptographic key set used for decrypting a test is created based on one or more biometric measurements each time the student puts on the Monitor. In this case, one Monitor can be used for any number of students and a student can use any Monitor. The student's biometrics, or data derived therefrom, can only be stored on the Monitor while it is in use by the student and erased when the student removes the Monitor. This also removes biometric privacy concerns. In some implementations, due to the cost and computational complexity of the software, the biometric, such as the iris scan, can be sent to an Internet server and converted into a unique code which is then returned to the Monitor. In this latter case, the iris image can be erased from the server.

Since the value of a degree from a prestigious institution can be immense, the motivation to cheat when taking a test can be enormous. An industry of consultants now exists for aiding students in cheating when taking tests and thus obtaining a degree. This invention where it is used will prevent the success of such consultants and thus assure the integrity of an earned degree.

If a student, when taking a test, is inclined to cheat, this inclination can be facilitated if a helper or consultant has access to the display which shows the test while it is being taken. If the consultant has such access, then he or she will use a communication method where he or she can transfer information to the test-taking student in a manner that cannot be detected. This invention is intended to reduce and ideally eliminate the opportunity of the consultant from observing the display or otherwise learning the content of the test questions and therefore being able to derive and communicate answers to the test-taker.

If the student were to use his or her private computer for displaying a test, it would be generally relatively easy for a consultant to attach a second remote monitor which would display the same information as the primary monitor. There exists software, for example, which permits someone who is even located remotely from a particular computer to observe the display of that computer. Alternatively, if the test-taker or his consultant has access to the ports and operating system of the computer upon which the test-taker takes tests, access to the information on the display is relatively simple to achieve. One method of preventing this is to design a device which prevents other computers from connecting with the device in such a manner that the display can be copied. Thus, in a preferred implementation of the invention, a special device, and in particular a wearable glasses type device, the Monitor, has been configured and provided to the student for those cases where the student desires credit for the course he or she is taking.

Various proctoring companies attempt to prevent the use of a second monitor, or access to the Internet, through various lockdown browser software. If the connection to a second monitor or computer is achieved with hardware, such as a splitter attached to the plug that connects the display to the processor, the lockdown browser software will not be able to detect this connection and thus is useless for its intended purpose.

Basic Monitor Embodiment

FIG. 1 illustrates a test-taker 10 taking a test using any one of various proctoring systems such as Examine or Proctor U. The test-taker 10 can get help when answering test questions if his/her consultant has access to these questions. This access can be accomplished in many ways such as through a hidden camera 11 embedded in a wall 14 facing a computer screen 15 used for administering the test, hidden on the test-taker 10 and looking through a hole in the test-taker's shirt 18 or embedded in a piece of jewelry 17, or, most easily, a transmitter can be built into the computer which transmits the contents of the display to the consultant in another room or in another country via the Internet. The consultant can be a person who already knows the material being tested or he or she can query the Internet for the answer.

Since the consultant can see the questions, there are countless ways that answers can be communicated to the test-taker 10 such as by projecting them on the floor, a wall or ceiling, placing a bone speaker in the test-taker's seat 16 where it will contact the test-taker's spine or on his/her shoulder under his/her clothes, for example. Even tying a string around the toe of the test-taker 10 and pulling three times for answer c can work. Broadcasting answers can be provided by smartphone 12 or tablet 13 behind the computer screen 15. None of these methods, and countless others, can generally be detected by an online proctor if the device is out of the proctor's view. It is thus not possible to prevent a consultant from communicating with the test-taker, leaving the only remedy left of preventing the consultant from knowing the test questions.

Of course, other methods are available such as bribing the proctor or someone that can provide a copy in advance of the test questions and answers. Prevention of these methods will be discussed below. Since cheating is easily accomplished using all known proctoring or other anti-cheating methods, there is an urgent need for a system that cannot be defeated. Until that is available, granting of meaningful credit for online education is not possible.

A device constructed in accordance with the teachings of this invention is illustrated in FIGS. 2 and 3 which are a perspective views of a head-worn glasses type device, generally referred to as a monitor 20, containing an electronics assembly (PCB) 22a with several sensors, cameras and a display, all protected with a chassis intrusion detector 22 (CID) prepared using teachings herein.

FIGS. 2 and 3 are views from the front and rear respectively showing the device or monitor 20 which comprises three main parts: plastic housing parts 21a and 21b (collectively referred to as a housing 21) and internal PCB parts covered by chassis intrusion detector 22 (CID) described below. Housing part 21a serves as a cover. Housing part 21b extends from an eyeglass frame 21c. Housing part 21b can be substantially L-shaped with a first portion extending straight outward from an edge of the frame 21c and second portion substantially perpendicular to the first portion and positioned in front of the frame 21c. The frame 21c has a lens portion including an aperture for receiving an optional see-through lens (prescription or plain glass) and a support portion extending rearward from the lens portion. The support portion may be two temples as shown, or an elastic headband as described below.

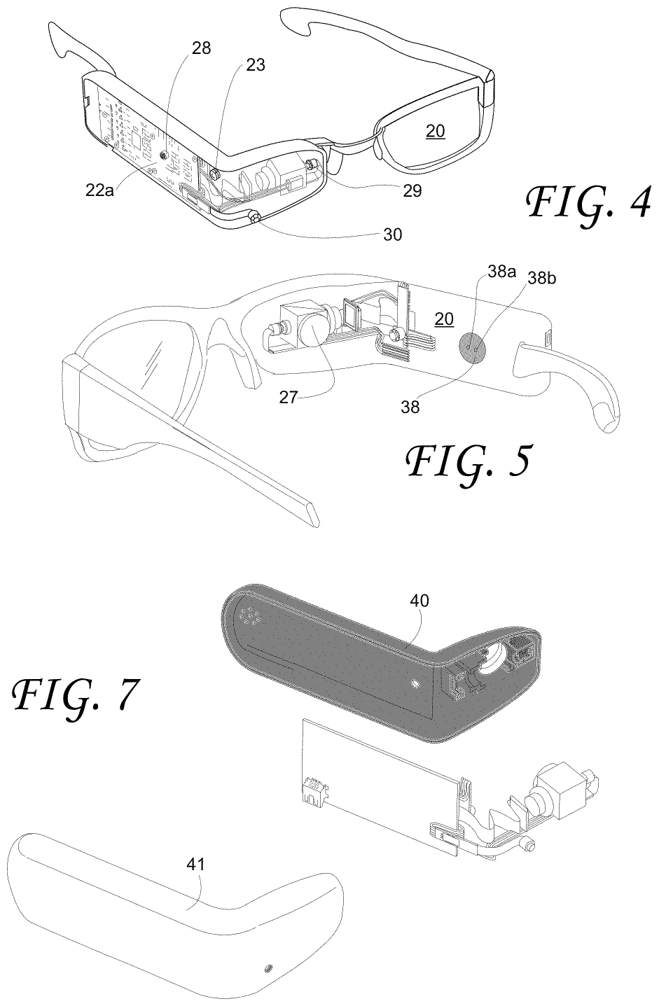

FIGS. 4 and 5 are perspective views of monitor 20 looking from the front and rear respectively showing a cross-view camera 23, a display 27, a contact microphone 38, and a microphone 28. A wire from the PCB 22a comprises, e.g., four flat conductors and passes though the CID 22. A USB plug 25, or similar device, is built in a way that it can snap into the housing 21. Plug 25 is located outside of the CID 22. Also illustrated are the contact microphone 38 with embedded contact sensor, which can be a skin temperature sensor (thermocouple), pulse from blood flow sensor (as in a pulse oximeter), or part of an EKG (ECG) sensor. An EKG sensor requires at least two sensors displaced from each other in order to get a measurement of the heart pulse shape. Only one is shown in FIG. 5. Also shown are the positions of the cross-view camera 23, microphone 24, iris camera 29, forward-looking camera 30, where monitor plastic housing part 21a and CID 22 (from FIG. 2) have been removed.

FIGS. 4 and 5 illustrate monitor cutaway drawings showing the internal design of the device. Display 27 is arranged in the housing part 21b and pointed toward the right eye of test-taker and displays test questions during a test (although alternatively, a display can be pointed toward the left eye of the test-taker). Forward viewing camera 30, representative of an imaging device, is also arranged in the housing part 21b and monitors the field of view of the test-taker outward from the monitor 20. Camera 30 can have a field of view (FOV) of approximately 120°, alternatively 2 cameras having individually a smaller FOV can be used. Buzzer or sound creator 28 can be arranged in the housing part 21b and periodically provides a sound detectable by the microphone 24 to verify that the microphone 24 has not been rendered inoperable. Microphone 24 and buzzer 28, or alternately a speaker, are on the PCB 22a and thus holes are located on the side of the housing 21.

Display 27 can be arranged at a terminal end of the second housing part 21b. The forward viewing camera 30, or other imaging device, the microphone 24 and the buzzer 28 can also be arranged on the side of the second housing part 21b (see FIG. 4). Each of these components can be connected to a processor-containing electronics package in housing 21 which can be mounted to the frame 21c in a manner known to those skilled in the art to which this invention pertains. A cable emanates from the electronics package in housing 21 and can contain the USB connector 25 for connecting onto an external device such as a power and communications module, smartphone or computer, or simply an external battery or wall power outlet.

The iris, or retinal scan, camera 26, can be arranged in housing 21, pointing inward toward the wearer, and measures biometrics of the test-taker (see FIG. 3). Such biometrics can include an iris or retinal image, image of the blood vessels in the white portion of the eye or an image of the portion of the face surrounding and likely including the eye. Illumination of the eye can be provided by LEDs arranged in the housing 21 which can be in the IR or visible portions of the electromagnetic spectrum. Iris camera 26 is therefore more generally considered a biometric scan camera.

Software and a processor which controls test administration can be resident on an external server of the test-provider and operates in conjunction with the electronics package in housing 21. Communication to and from this external server can be via the Internet.

Camera 23 can also be provided in housing 21 to check for any anomalous activity which might take place near the glasses (see FIG. 3). Such a camera 23 can enable detection of whether an image capture device has been either temporarily or permanently affixed to the monitor 20 or to the face of the test-taker which can capture the image on the display 27. Similarly, camera 23 can monitor the space surrounding the left eye of the test-taker to assure that such an image capturing device and or another display for providing aid to the test-taker is not being employed by the test-taker in conjunction with his left eye. This is achieved by processing images obtained by the camera 23 using an image processing algorithm to determine the presence of another image capture device or display, e.g., image comparison or more generally image analysis. The camera 23, or more generally an imaging device, is arranged on the first housing part 21a and oriented to image most of the frame 21c (see FIG. 3).

To further discourage cheating, if the test-providing institution is providing tests to 1000 test-takers either simultaneously or at different times, and if the test is of a multiple-choice type and contains fifty questions, the order of the questions and of the answer selections can be scrambled and thus different for each test provided. Since this provides a very large number of different tests each containing the same questions, there is little risk that answers from one set of questions can be of any value to a test-taker taking a different ordered set of the same questions.

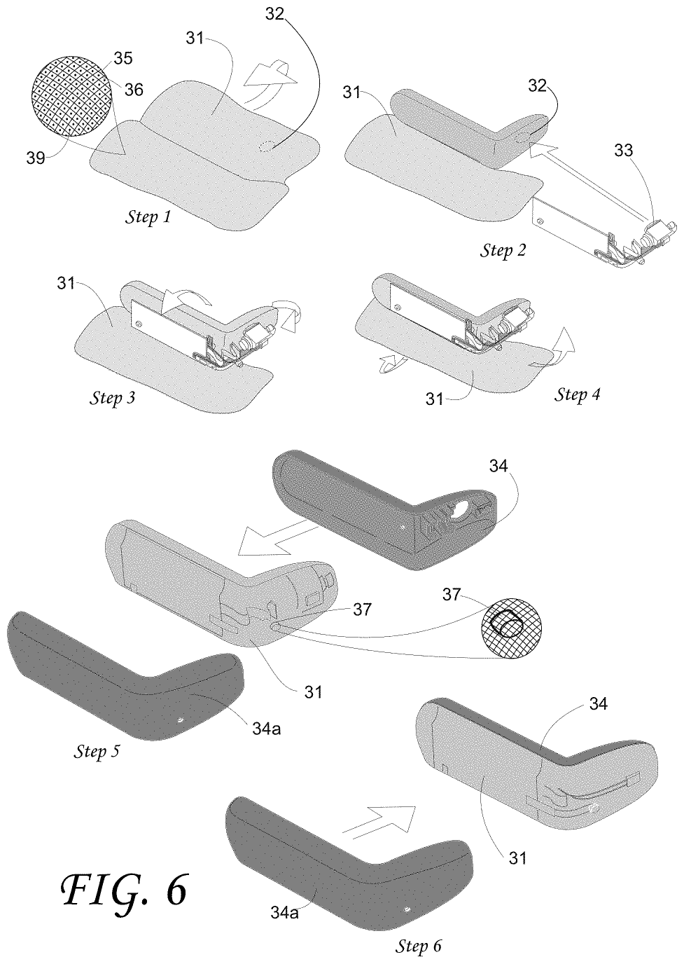

The entire electronics package of the device 20 (FIGS. 2-5) is encapsulated in a thin film 31 (FIG. 6) called a chassis intrusion detector (CID). As described herein, an array of wires can be printed, or otherwise affixed, onto a plastic film encapsulating the electronics package, including the display and cameras, in housing 21 such that any attempt to break into the housing 21 will sever one or more of the wires.

A private key, or the code for generating such a key as explained in more detail below, for decoding the test questions and any other commands sent by the test-providing institution can be held in volatile RAM memory in, for example, housing 21. This can be kept alive through an extended life (10 years) battery which also can be recharged when the monitor 20 is connected to a power supply (not shown) through connector 25. If the chassis intrusion detector 22 detects an attempt to break into the housing 21, then power to the RAM memory can be shut off and the private key and any other private information or algorithms will be erased. Other techniques to disable the operability of the monitor 20 for a test as a result of the detected attempt to break into the housing 21 are also possible, either alternative or additional to the erasure of the private key.

When the test-taker is preparing to take a test, he or she will place the monitor 20 onto his or her head. An image will be acquired of the iris, retina, or other biometrics by camera 26 and sent to a server via a secure telecommunications network and/or the Internet. The server will convert the iris image to a code and return the code to the monitor. Using an algorithm resident in the monitor, the monitor can convert the code from the server to a cryptographic key set and return the public key to the server. The server will then associate and store the public key with the test-taker's ID. At the completion of this process, test questions will be transmitted to the monitor 20 encrypted with the test-taker's public key, decrypted by the monitor using the test-taker's private key and displayed on the display 27, for example, one at a time.

The private key development algorithm can be held in the CID volatile ROM memory and placed thereon during monitor manufacture after the CID has covered the electronics, display and sensors of the monitor. This algorithm is erased if power is lost to the ROM or RAM memory such as will happen if a wire making up the CID is cut as entry is attempted. The algorithm can comprise any of many functions which are known to those skilled in the art which can create a unique cryptographic key set based on an iris code in a manner which cannot be duplicated without knowledge of the algorithm. The algorithm is kept secure by the monitor supplier and is only released in conjunction with the manufacture of a monitor. Once on a monitor, the algorithm cannot be retrieved and any attempt to do so will cause it to be erased. Thus, the key generation algorithm cannot be duplicated on any other device.

An alternate approach is to not associate the private key with the test-taker but rather with the Monitor. In this case a key set is generated when the Monitor is manufactured, and the private key is loaded onto the Monitor and associated with a Monitor ID. If the CID is breached, the private key is erased.

The iris camera 26 is controlled to periodically check to ascertain that the test-taker's iris is present and that it has not changed. This is controlled by the processor on PCB 22a in the monitor 20. If anything anomalous occurs, such as the absence of an iris or eyeball or the change of position of the iris or eyeball, then the display 27 will be deactivated by the processor. Thus, when the test-taker removes the monitor 20, the display 27 will automatically stop displaying test questions. Similarly, if the test-taker transfers the monitor 20 to another person whose iris does not match that of the test-taker, then the display 27 will not show test questions. Above and in what follows, the iris will be used to represent any of the aforementioned biometric scans observable by camera 26.

When the test-taker has completed answering the test questions, he or she can indicate such through the mouse or keyboard (user interface) and the display 27 will no longer display test questions. The remainder of the interaction with the test-providing facility can then occur as described below.

Forward-looking camera 30 can have a field of view (FOV) of about 120° or, alternatively, more than one camera each with a lesser FOV view can be provided. This FOV will cover the hands of the test-taker to check for the case where the test-taker is typing in the questions on a keyboard where they are transmitted to a consultant. If the hands of the test-taker cannot be seen by camera 30, i.e., are not in images obtained by the camera 30, the display 27 will be turned off until the hands can be seen. If this happens frequently, the test can be terminated. Camera 30 can also be used to check for the existence of other devices near the test-taker. These devices may include a tablet or other computer, a smart phone, books or papers, displays, or any other information source, including notes projected onto the ceiling, wall or floor, which is not permitted to be used for the particular test. If the test is an open book test, then use of some of the above-listed objects can be permitted. Software which accomplishes these pattern recognition tasks can utilize one or more trained neural networks and reside either on the server or the monitor.

The test-taker may have enabled a hidden switch, or redefined a key, which disconnects the keyboard, when a keyboard is allowed, from the monitor 20 and connects it to a consultant thereby enabling the test-taker to send test information to the consultant. Camera 30 can determine that the test-taker is typing, and the processor can ascertain that the monitor 20 is not receiving the typed information and indicate a fault. For most tests, a keyboard will not be necessary and thus it can be eliminated from the setup to minimize its use for consultant communication. As described below, a virtual keyboard can be provided when typing is required.

A limited number of encrypted commands which relate to the test being administered can be transmitted with the encrypted test from the test-providing institution or test administrating facility. These commands control some aspects of the test-taking process such as whether it is an open book or closed book examination, whether it is a timed test and if so how much time is allowed, how many restarts are permitted, how many pauses are permitted etc. Since the test process is controlled by the monitor 20, these commands will be decrypted and used to guide the test-taking process by the monitor 20.

Camera 30 similarly can be used to check for anomalies near monitor 20. Again, the pattern recognition software used with camera 30 can utilize one or more trained neural networks. Camera 26 can check for small cameras which may have been glued to the face of the test-taker, for example, by comparing images and/or using pattern recognition via a processor, and that can capture a view of the image displayed on display 27. Also, the FOV of the display 27 can be limited so that only the area near the eye of the test-taker can see the display 27. Thus, to see and capture the display 27, a camera will need to be near the path from the display 27 to the eye. Furthermore, the design of the monitor 20 can be such as to minimize the available structure which would permit the installation of a hidden camera.

Contact microphone 38 can snap onto the housing 21 and be located on the inward side of the housing 21 so that it is in direct contact with that portion of the housing 21 alongside one of the temples. At this location it can be pushed against the cheek of the wearer when the wearer is wearing the monitor 20. In this non-limiting configuration, contact microphone 38 can contact the wearer's face, for example, along a portion of the housing 21 at the cheek or other portion of the face. The function of the contact microphone 38 is to detect any vibrations such as are caused by talking or even whispering by the test-taker, or generally any sounds being emitted by the test-taker which necessarily result in vibrations of the bone and/or skin. These vibrations are detected as a result of contact of the contact microphone 38 with the skin of the wearer, and ideally when pressed against a facial bone of the wearer. The functionality of the contact microphone 38 may be incorporated into another component that would also be considered equivalent to a contact microphone, namely, any component that is able to sense or detect vibrations through contact with skin or another body part which vibrates whenever the test-taker is talking or making other oral sounds. As explained below, a contact speaker can also be provided to check that the contact microphone is against the face of the test-taker and functioning properly.

Housing 21 can also have two holes, one for a small LED 38a and the other for a small photocell 38b (see FIG. 5). Each hole can be about 2 mm or less in diameter. They may be placed in the center of the contact microphone 38 and holes can be drilled through the microphone 38 for the wires from the photocell 38b and LED 38a to travel to the PCB 22a. An alternative is to replace the LED 38a and photocell 38b with a thermocouple or thermistor which measures the skin temperature of the test-taker. In either case, the purpose is to ascertain that the contact microphone 38 is pressed against the face when the monitor 20 is worn by the test-taker so that it will sense any sounds coming from the mouth of the test-taker, that is, to determine contact between the contact microphone 38 and the skin of the wearer.

Generally, there should be no talking while test-taking is in progress. Microphone 24 is used to detect audio sounds and spoken words. If such words are detected particularly emanating from the test-taker, then a responsive action to halt the display of test questions can be undertaken, for example, the test can be paused or terminated depending on the test-providing institution's requirements.

To prevent the microphone 24 from being covered with sound absorbing material, a speaker, or other sound creator 28 is provided to periodically create a sound which is detected by the microphone 24 and the quality of the detected signal can be ascertained. If the microphone 24 cannot clearly hear the sound produced by the sound creator 28, then the test can be terminated until the issue is resolved. Sound creator 28 may be placed at an alternate location on the housing 21 or frame 21c to minimize direct sonic conduction through the structure. As described below, the speaker can be incorporated into the contact speaker used to check the contact microphone.

Device Block Diagram and System Flow Chart

A representative device block diagram is illustrated in FIG. 11 which is generally applicable for devices and monitors disclosed herein. The device is represented generally as 350 and typically comprises a (micro)processor generally at 352 which further can comprise a CPU 353, a display interface 354, an iris camera interface 355, a forward view camera interface 356, a cross view camera interface 357, an eMMC (embedded Multi-Media Controller) 358, RAM 359, a communication interface 360, a LED control interface 361, a display optical interface 362. Also in the device 350, there can be a display 363, an iris camera optical interface 364, an iris camera 365, a forward view camera 366, a cross view camera 367, a iris camera LED 368, a buzzer or other sound maker 369, an audio and/or contact microphone 370, a Wi-Fi module 371, a mouse/keyboard interface (Bluetooth) 372, a battery 373, a CID battery and mesh 374, a CID controller 375, a data and charger interface 376 and an optional external camera Wi-Fi interface 377.

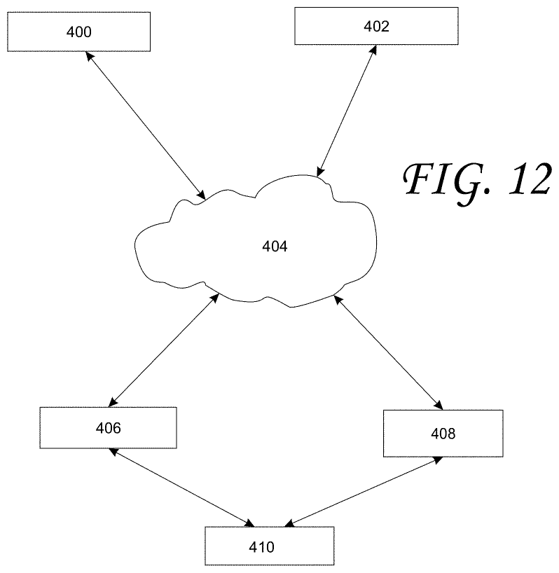

A system block diagram is shown in FIG. 12 and comprises a server 400, a Test-Provider or test-providing institution or test-administrating institution 402, a communications network 404, one or more monitors or devices 406, a computer 408 and the user 410.

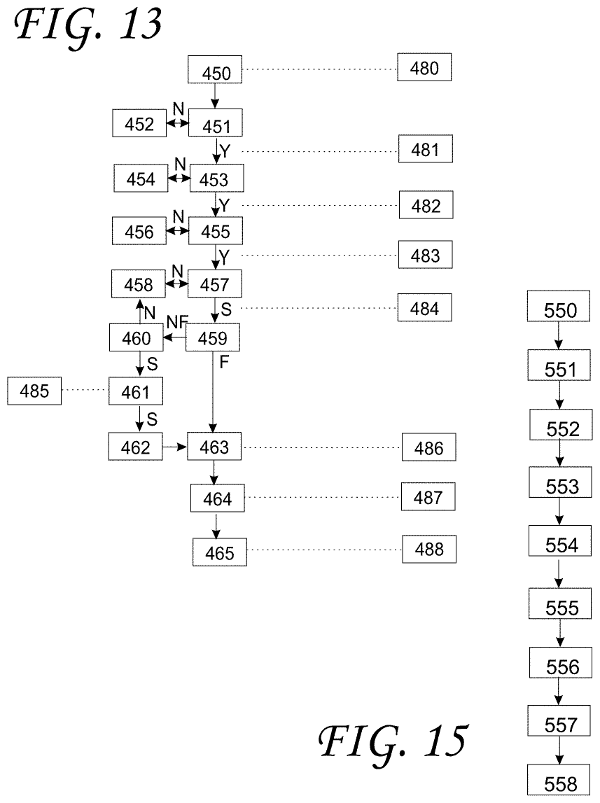

An administrator flow chart is illustrated in FIG. 13 and can comprise the following steps, not all are required and others can be added:

| | |
|---|---|
| 450 | User plugs in monitor |
| 451 | Mouse and keyboard connects |
| 452 | Mouse and keyboard setup |
| 453 | Wi-Fi connects |
| 454 | Wi-Fi setup |
| 455 | Iris scan |
| 456 | Wait |
| 457 | Web call |
| 458 | Troubleshoot |
| 459 | Get name |
| 460 | Web call |
| 461 | Send iris digital image and Monitor/Device ID |
| | Server can return iris code to Monitor/Device |
| | Monitor/Device creates cryptographic key set based on iris code |
| | and proprietary algorithm if this method is used |
| | Monitor/Device sends public key to server if this method is used |
| 462 | Iris, Monitor/Device codes and user public key linked with user |
| | and added to list on server if this method is used |
| 463 | Test-taker authenticated |
| 464 | Choose test to take |
| 465 | Proceed to test-taking sequence |
| 480 | Display “Power is on” |
| 481 | Display “Mouse and keyboard connected” |
| 482 | Display “Wi-Fi connected” |
| 483 | Display “Iris scanned” |
| 484 | Display “web call successful” |
| 485 | Display random number e.g. “234 342 907 enter |
| | using login computer” alternatively a keyboard, |
| | virtual or real, linked to monitor can be used. |
| | This only needs to be done once and can be |
| | done on the Monitor. |
| 486 | Display “Welcome Ann Smith” |
| 487 | Display list of user's available tests |
| 488 | End of login sequence |

When this is accomplished, a signal can be sent to the server indicating that the test-taker is ready to take the examination. Note that an alternative would be for the iris code to be created on the Monitor 20 which eliminates the need to send the iris image to the server. This increases the computational requirements of the Monitor-resident processor but eliminates any concern that the iris biometric image is stored by the server.

The proposed running sequence is as follows:

1. A test-taker places the Monitor 20 on his or her head, establishes a WiFi or cellular connection and, using the mouse, initiates the acquisition of his/her iris image.

2. The iris image is transferred to the test management and supplying server, hereinafter called SecureTest server, where it is used to create the iris code using standard software.

3. The iris code is sent back to the Monitor 20 if this method is used.

4. The Monitor 20, using a secret and/or proprietary software algorithm, creates the SecureTest test-taker ID and cryptographic key set from the iris code if this method is used.

5. If this is the first initiation, the test-taker enters his university student ID which is sent to the SecureTest server

6. The Monitor 20 sends the Monitor ID, the student ID and public key (which can be the same as the Monitor ID) to the SecureTest server if this method is used.

7. The SecureTest server validates that this is a registered student.

8. Later, for software updates, new software can be loaded over WiFi or other network from the SecureTest server whenever desired using the student's public key. Once the sequence above is completed, the SecureTest server sends a code indicating that a software update will follow.

What is generally not realized is that teachers and administrators play a significant role in cheating. Alleged cheating behaviors include the following and how it is avoided using the Monitor based test system described herein:

1. Changing test-takers' answers after the test. When the test is completed, the answers can be first encrypted using the SecureTest public key and then again using the school's public key. The SecureTest server will generally grade the test and forward the test grade to the school. If there is any doubt as to whether the answers were changed, the two encrypted copies of the test answers can be compared. Alternatively, they can be routinely compared to check for cheating.

2. Teaching to the test. A significant number of potential test questions can be generated based on the subject matter to be tested. When a particular test is to be given to a class, questions can be chosen at random from this much larger list. Therefore, the teacher cannot teach to the test since no one will know ahead of time what questions will be on the test.

3. Illegal coaching during a test. Since each test-taker taking the test will have a different test and conversation between the test-taker and any other person will be captured, it is not possible to coach the test-taker during the test.

4. Using live exams as practice exams. Generally, the instructor should not know what the test questions will be and therefore they cannot be used as practice exams.

5. Reading off answers during a test. Since the instructor will not know the test questions and each test-taker will have the questions presented in a different order, also since any audio conversation can be monitored and recorded, it is not possible to read off the answers to the test during the test period

6. Providing extra time for tests where there is a time limit. This can be made part of the control system of the monitor. In other words, each test will be allowed a certain amount of time. Extra time therefore cannot be allocated without that fact being known.

7. Disallowing low-achieving students from testing. A low achieving student will not be able to get credit for the course unless he or she has successfully passed various examinations.

Generally, the tests administered by the Monitor will be closed book tests in which case the forward looking camera should not see any books, notes, laptop computers, cell phones etc that could be used by the test-taker to get the help of a consultant. In a later implementation of the monitor described below, limited access to the Internet can be allowed using the monitor. For that situation the monitor will have a very large display including multiple screens and access to a particular website, for example, can be provided and the information that is on that website can be controlled such as to include all of the relevant information needed to answer a test question without simultaneously giving access to a consultant. The student can be permitted to add notes and other information to the website.

If cheating is detected while a test-taker is taking a test, the test-taker can be warned that cheating has been detected and that if it is not stopped the test will be terminated. In the rare case where their test was terminated due to an error in the cheating detection algorithms, the test-taker can be given the opportunity to retake the test which can involve questions in a different order and even different questions.

Note that the test-taker's or monitor's private key is never transferred off the monitor. Thus, if the encrypted test is intercepted it cannot be decrypted.

The long-term goal for the monitor is to be the vehicle where students learn as well as take tests as explained in more detail below. As such, the monitor should facilitate reading and marking of text, viewing lectures or books, augmented reality and maybe even virtual reality.

With the internet becoming ubiquitous (as in 5G), the Monitor can be used for delivering MOOCs, textbooks as well as tests.

Monitor Operation

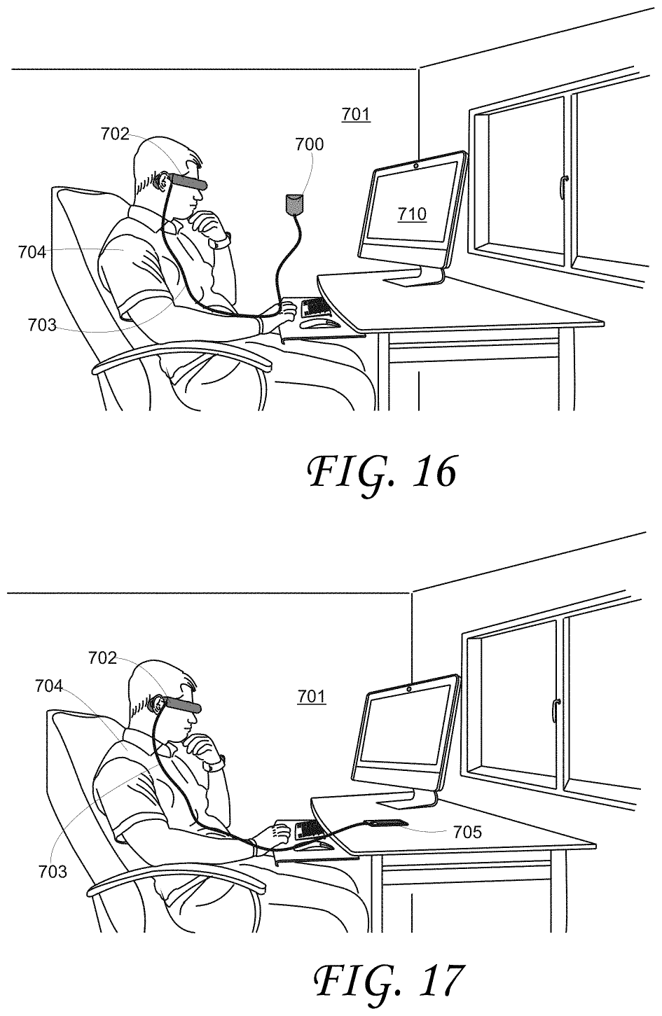

FIG. 16 shows a Wi-Fi module 700 plugged into a wall 701 via a cable 703 to provide power to the monitor 702. Alternatively, a battery pack can be provided removing the need for a wall connection and providing portability or batteries can be integral with the monitor. A desktop or laptop computer with a display 710 can be used by the student for registering with a school or other institution which will provide the tests to be taken using the monitor 702. The connection to the Internet can be either arranged though the wall plug 700 which can contain a Wi-Fi receiver or through a Wi-Fi transceiver within the monitor 702. Either the wall plug, or the monitor 702, can also contain a Bluetooth receiver for interfacing to a mouse and/or keyboard.

FIG. 17 illustrates a situation, like FIG. 16, but where the monitor 702 plugs into a smartphone, PC or tablet (device) 705. In this case, the Internet and Bluetooth connections can be through the device 705.

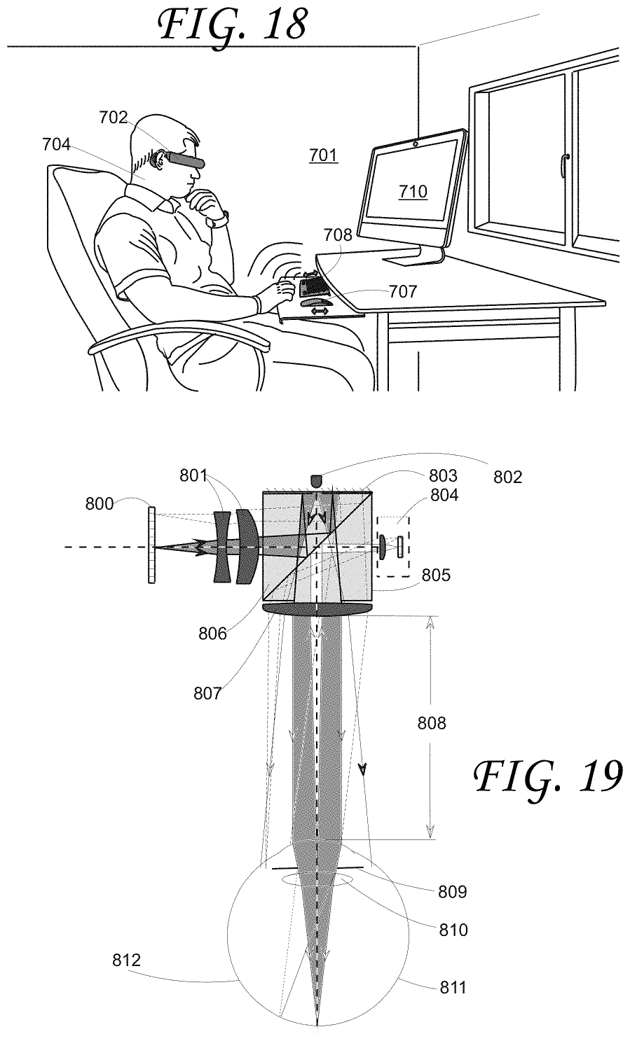

The connection between the monitor 702, mouse 707 and keyboard 708 is illustrated in FIG. 18 with the following features:

a. Monitor 702 is started when mouse 707 or keyboard 708 is activated.

b. Mouse 707 or keyboard 708 can be used to control the display 710 for registration and test selection through an Internet connection, etc.

c. Other devices can also be controlled using the mouse 707 or keyboard 708 and are discussed below.

A test-taker can have access to a keyboard 708 and/or a mouse 707 for interacting with this server for initial registration (FIG. 18). Using a mouse 707 or keyboard 708, the test-taker initiates the test-taking process through communication with the test-provider or their institution's server (see FIG. 12). When the test is ready for execution by the test-taker, an encrypted version thereof is transmitted to the monitor 702 from the server via a network, see FIG. 12. An electronics package in the housing of the monitor 702 includes a processor that can utilize a private decryption key to decrypt the test questions and cause them to be displayed on the display within monitor 702, described above. The test-taker enters answers to the questions using the mouse 707 and/or keyboard 708 or other user interface.

Some precaution may be required in the case where a keyboard 708 is used to prevent the test-taker from using the keyboard 708 to communicate with a consultant. Keyboard 708, for example, may have a hidden switch, or a specially defined key, that disconnects it from the monitor 702 and connects it to the consultant. The monitor 702 will know through the forward-viewing camera that the test-taker is entering information via the keyboard 708 and if that information is not detected by the monitor 702 through the keyboard interface, then communication to the consultant may be taking place and the test can be terminated or other appropriate remedial action taken.

2. Test Taking Procedure

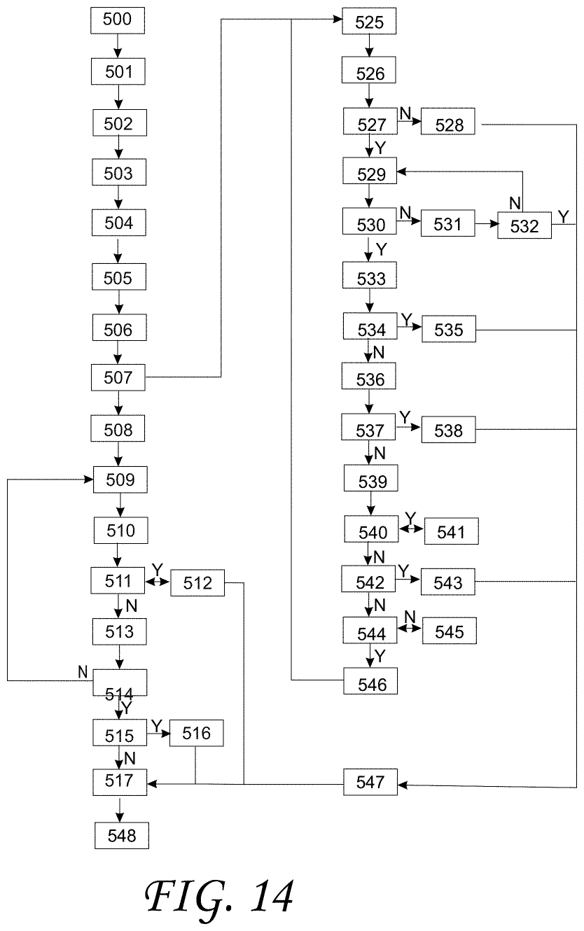

A representative test-taking sequence is illustrated in FIG. 14 and can comprise the following steps, again not all are required:

| | |
|---|---|
| 500 | User selects test to take |
| 501 | Web server obtains the test from the test-provider |
| 502 | Monitor/Device creates cryptographic key set based on iris |
| | code and proprietary algorithm for this method |
| 503 | Web server obtains public key from Monitor/Device |
| | for this method |
| 504 | Web server processes and encrypts the test using |
| | Monitor/Device public key |
| 505 | Encrypted test is transferred to Monitor/Device using https: |
| 506 | Monitor/Device decrypts test using its private key |
| 507 | Start test monitoring |
| 508 | Start test timer and initialization of other parameters |
| | (pupil, # of pauses etc.) |
| 509 | Monitor/Device displays next test question |
| 510 | User chooses multiple choice answer using mouse |
| | which is recorded |
| 511 | Has allotted time been exceeded? |
| 512 | Display “maximum test time exceeded” |
| 513 | User advances or goes back to another question or |
| | indicates test is done |
| 514 | Is user done taking test? |
| 515 | Has pupil size change flag been set? |
| 516 | Send warning message to server |
| | “possible fake iris contact lens in use” |
| 517 | Display “End of test”, transfer test answers to server, |
| | stop monitoring |
| 525 | Start test monitoring tasks |
| 526 | Acquire iris image - flash white LED or turn on IR LED |
| 527 | Compare iris image with memory |
| 528 | Display “Iris has changed, unrecoverable error” |
| 529 | Acquire eye location image, measure pupil diameter and set flag if |
| | pupil diameter has changed |
| 530 | Is eye located properly and has pupil diameter changed |
| 531 | Display “eye location error, test paused, right click to restart” |
| 532 | Increment pause counter, check for maximum |
| | pauses and sense right click |
| 533 | Acquire cross-view camera image |
| 534 | Analyze cross-view camera image for anomalies |
| 535 | Display “cross-view image contains an anomaly, |
| | unrecoverable error” |
| 536 | Acquire forward view camera image |
| 537 | Analyze forward view camera image for anomalies |
| 538 | Display “forward-view image contains an anomaly, |
| | unrecoverable error” |
| 539 | Activate buzzer |
| 540 | Acquire and analyze sound interval from microphone |
| 541 | Display “warning sound from microphone contains an anomaly” |
| 542 | Acquire interval of sound from contact microphone |
| 543 | Display “User is talking, unrecoverable error” |
| 544 | Acquire and analyze interval of heartbeat data or skin |
| | temperature data from blood flow monitor and EKG data |
| 545 | Display “contact microphone not in contact with cheek contact” |
| 546 | Wait 1 second and then Continue |
| 547 | Display “Test terminated on error” |
| 548 | End of test (after 517) |

When the test-taker engages in taking a second test later, a new biometric scan will be conducted to ascertain that this is the same person who originally registered using monitor 20. If this scan comparison is successful (as determined by a processor), then the display 27 will be activated and a signal can be sent by the processor to the test-provider to forward the encrypted test.

There are various sensors including the forward-looking camera, the iris imaging camera, the cross-view monitoring camera, and the microphone and contact microphone, that provide data which contain patterns which are appropriate for neural network analysis. In some cases, initially this analysis can be simplified by using differences between two images. For example, for the cross-view camera which monitors the space from the eye to the display, it is expected that the image from this camera should be invariant and therefore any significant changes in that image would be indicative of an anomaly which should be brought to the attention of the test-taker for remedial action. Similarly, once the test has begun, there should be no voices sensed by the microphone 24 or the contact microphone 38 and therefore if any voice frequencies are present, the anomaly can be highlighted for remedial action by the test-taker. This lack of sound requirement for microphone 24 may be difficult to enforce so a contact microphone 38 is provided to detect whether the test-taker is talking. If talking is detected, the test can be interrupted and if it happens a second time, the test can be terminated or other sound-detection responsive protocol followed. An exception to this rule is when a voice biometric is used to further ascertain the identity of the test taker. In addition, some tests may permit a spoken answer to an essay question, for example, in which speaking by the test taker can be permitted.

Eye image analysis to detect that the eye is properly located in the FOV of the iris camera can be somewhat more complicated, however, again since it is the difference between two such images which is significant, the analysis can be relatively uncomplicated. Iris identification biometric software is commercially available and may not impose a significant computational load on the processor or the computations can be done on the server. Generally, it will be done on the remote server. In order to guard against use of a contact lens with a painted surface showing an invariant iris image to an iris imaging camera, the size of the pupil is monitored by the monitor 20 via pupil image analysis. The pupil diameter changes over time even when the background lighting level is invariant. Therefore, if by the end of the test, the pupil has not changed in diameter such a painted contact lens is suspect and can be flagged as an anomaly.

Classroom Testing

FIG. 36 illustrates the use of the apparatus in accordance with the invention by a room full of test-takers where each device can be attached to a central computer 1306 through a USB port, for example. In this case, each test-taker 1302 is provided with a keyboard and/or a mouse or other input device, and a display 1304. Each device can be connected to a central computer 1306. Otherwise, the operation of the Test Glasses is as described herein. Each test-taker is presented a different version of the scrambled test and uses the keyboard and/or mouse to answer the test questions. The central computer knows which test version is being answered by each test-taker so that the information can be used for grading the test. Since each test-taker is provided a different scrambled version of the test, the answer provided by one test-taker cannot help another provided talking is not permitted.

FIG. 37 is a view similar to FIG. 36 where the answers are placed on a piece of paper which will be collected by the test proctor at the conclusion of the test. Again, since each test-taker will be taking the same test with the questions randomly reordered, there is little advantage in a test-taker surreptitiously communicating an answer to another test-taker. Thus, by virtue of the arrangements depicted in FIGS. 36 and 37, the Test Glasses can be used either remotely or in a classroom environment.

According to another simplified version of the monitor, a device constructed in accordance with the teachings of this invention is illustrated in FIG. 38A which is a perspective view of a head worn glasses type device, the Test Glasses or Monitor, containing an electronics assembly with several sensors, cameras and a display, all protected with a chassis intrusion detector as described elsewhere herein, prepared using the teachings herein. A head worn display and electronics device constructed in accordance with the invention is shown generally at 1410 in FIGS. 38A and 38B.

A housing 1420 extends from a frame 1422. Housing 1420 is substantially L-shaped with a first portion extending straight outward from an edge of the frame 1422 and second portion perpendicular to the first portion and positioned in front of the frame 1422.

A display 1412 is arranged on or in the housing 1420 and pointed toward the right eye of test-taker displays the test questions (although alternatively, a display can be pointed toward the left eye of the test-taker). A forward viewing camera 1414, representative of an imaging device, is also arranged on or in the housing 1420 and monitors the field of view of the test-taker outward from the device 1410. The camera 1414 can have a field of view of approximately 120°. A microphone 1416 is also arranged on or in housing 1420 and monitors talking (sounds) which can take place while the test is in progress. A sound maker or speaker 1418 is arranged on or in the housing 1420 and periodically provides a sound detectable by the microphone 1416 to verify that the microphone 1416 has not somehow been rendered inoperable. The speaker 1418 may be placed further away from the microphone 1416 and insulated from the housing 1420 so that the microphone 1416 does not receive the sound from the speaker 1418 through the housing 1420 instead of the air surrounding the device 1410.

The display 1412 is arranged at a terminal end of the second housing portion. The forward viewing camera 1414, or more generally an imaging device, the microphone 1416 and the speaker 1418 are also arranged on the second housing portion (see FIG. 38A).

Each of these components 1412, 1414, 1416, 1418 is connected to a processor-containing electronics package in housing 1420 which is mounted to the glasses frame 1422 in a manner known to those skilled in the art to which this invention pertains. A cable emanates from the electronics package in housing 1420 and can contain a USB connector 1424 for connecting onto an external device such as a computer, battery pack or wall power supply.

An iris or retinal scan camera 1426 is arranged on housing 1420, pointing inward toward the wearer, and measures biometrics of the test-taker (see FIG. 38B). Such biometrics can include an iris or retinal scan or a scan of the portion of the face surrounding the eye. Illumination of the eye can be provided by LEDs 1428 arranged on the housing 1420 which can be in the IR or visible portions of the electromagnetic spectrum. If white LEDs are used, then provision can be made to limit the intensity or the time that they are turned on so as not to annoy the test taker. Two or more different levels of visible illumination can be provided to cause the iris to be seen at different openings to check for an artificial iris painted onto a contact lens. The iris scan camera 1426 and LEDs 1428 are arranged on the second housing portion (see FIG. 38B).

A camera 1430 can also be provided on or in housing 1420 to check for any anomalous activity which might take place in the vicinity of the device 1410 (see FIG. 38B). Such a camera 1430 can enable detection of whether an image capture device has been either temporarily or permanently affixed to the device 1410 or to the face of the test-taker which can capture the image on the display 1412. Similarly, camera 1430 can monitor the space surrounding the left eye of the test-taker to assure that such an image capturing device and or another display for providing aid to the test-taker is not being employed by the test-taker in conjunction with his left eye. The camera 1430, or more generally an imaging device, is arranged on the first housing portion and oriented to image most of the frame 1412 (see FIG. 38B).

Software and a processor which controls administration of tests can be resident on an external computer, in the electronics package in housing 1420, or in another device, not shown, which attaches to the device 10 through connector 1424. A test-taker will have access to a keyboard and/or a mouse for interacting with this computer, not shown. Using a keyboard, the test-taker can initiate the test taking process through communication with the test provider. When the test is ready for execution by the test-taker, and encrypted version of the test is transmitted to the computer and relayed to the device 1410. The electronics package in housing 1420, e.g., including a processor, utilizes a private decryption key to decrypt the test questions and cause them to be displayed on display 1412. The test-taker then enters the answers to the questions using the mouse or keyboard and the computer display.

3. Chassis Intrusion Detector

A schematic of the operation of the chassis intrusion detector 22 is provided in FIG. 6. Since the chassis intrusion detector 22 is designed to encompass the entire electronics and sensors assembly, it must be relatively thin so as not to interfere with the contact microphone 38 (FIG. 5), microphone 24 (FIG. 3) and speaker or sound creator 28 (FIG. 4) and be transparent such as to not interfere with the display 27 or camera 26.

The CID 22 (FIG. 2) is a thin film which wraps around the PCB 22a and other parts. It can be made from a single sheet folded over and then glued together. It must conform closely to the camera 26 and display lenses so as not to distort the images. A wire to the USB connector 25 will be very thin where it goes through the CID 22. Connector 25 can snap into a holder built into the housing 21.

A preferred construction, as illustrated in FIG. 6, is to provide a single film layer (film 31) comprising a labyrinth of wires 35, 36 which are very narrow and closely spaced such that any attempt to penetrate the film 31 will cause one or more of these wires 35, 36 to be cut. The base film 31 can be made from polyimide onto which is printed the electric wires 35, 36. The final assembly is covered with a thin coating to insulate the wires 35, 36. A microprocessor (not shown) monitors the total resistance, inductance and/or mutual inductance of a circuit including the wires 35, 36 and erases the private information if there is a significant change in these measurements, e.g., above a threshold. Since any attempt to break into the electronic and sensor assembly will necessarily sever one of these wires 35, 36, this design provides an easily detectable method of determining an attempt to intrude into the system electronics and sensor assembly.

CID 22 has following properties:

1. The wires 35, 36 can go along both sides of the film (FIG. 6). They can be run one way on one side and cross at right angles on the other side. Alternately, a wire can be printed only on one side of the film.

2. The wires 35, 36 on one side can be connected to those on the other side by plated through holes so that there can be one continuous circuit. Alternately, the wires can be arranged so that there are multiple circuits which can be connected together in parallel to form more than one circuit each of which is separately monitored or the total impedance of the separate branches can be added together and the sum monitored. By this method, the total resistance of a branch can be kept within easily measurable bounds. Normally, the wire width is kept small so as not to interfere with the passage of light where the CID 22 covers displays and cameras. If the resistance gets too high, the wires can be made wider at locations where they do not cover cameras or displays.

3. On the underside near the mating socket in the PCB 22a, the wires 35, 36 can get wider (˜200 microns) so that a 2-pin connector can be attached.

4. The CID 22 can have very small holes 39 (about 50 to about 100 microns diameter) located in the centers between the wires 35, 36, or alongside of wires when only one side has wires, to allow it to breathe to prevent the buildup of heat from the electronics.

Assembly procedure may comprise the following steps (FIG. 6):

Step 1: prepare to wrap film 31 constituting the CID 22 around PCB 22a.

Step 2: wrap CID 22 over the PCB 22a. A critical step here is the attachment of the CID 22 to a display lens 33. Circle 32 can be a marked location on the CID 22 opposite the position of display lens 33. Circle 32 can be glued to the display lens 33.

Steps 3, 4: after gluing the PCB assembly, plug the CID 22 into the PCB 22a and wrap the rest of CID 22. Now, the PCB 22a is fully covered by the film 31 to form the CID 22.

Step 5: insert PCB 22 in housing 34; forward looking camera 37 and cross view camera are covered by the film 31 of the CID 22.

Step 6: Snap housing part 34a (like housing part 21a) into the housing 34 (like housing part 21b).

FIG. 7 shows the unassembled device housing: rear housing part 40 and front housing part 41 which are similar to housing parts 21b, 21a, respectively.

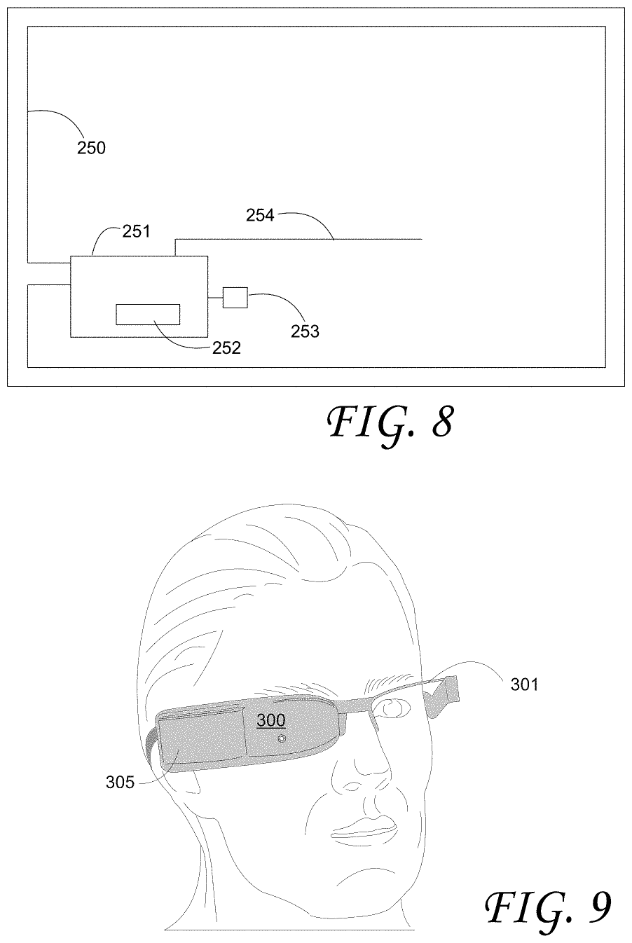

FIG. 8 illustrates that the chassis intrusion detector (CID) can contain its own microprocessor security assembly 251, containing the circuit property monitoring processor and battery 253, or they can be located on the PCB 22a. The CID 22 can also contain its own RAM memory 252. The RAM memory 252 can contain the private key and/or key generating code and other private information which is kept alive and thus usable by the battery 253. The battery 253 is chosen such that it can provide enough power to maintain the RAM memory 252 active for several years and also provide power to the microprocessor security assembly 251 to monitor the wire labyrinth. The conductive wire is attached to the microprocessor which checks, for example, the resistance or impedance of the wire. Any change in impedance detected by the microprocessor is indicative of an attempt to intrude into the interior of the electronics and sensors assembly. If such intrusion is detected, power is removed from the RAM memory 252 and the private information is erased.

A representative device assembly sequence is illustrated in FIG. 15 comprising the following steps (not all are required):

| | |
|---|---|
| 550 | Assemble parts |
| 551 | Place CID in fixture |
| 552 | Place electronics and optics in fixture |
| 553 | Apply adhesive to display lens, camera lenses, |
| | contact microphone, heartrate monitor and |
| | CID edges. Note, if EKG pads are used, they generally must |
| | be glued to the outside of the CID and |
| | provision needs to be made |
| | to pass connections through |
| | the CID which can be done by small pass |
| | through elements. |
| 554 | Close fixture |
| 555 | Wait for adhesive to set |
| 556 | Remove assembly with CID from fixture |
| 557 | Place in housing |
| 558 | Snap housing together |

A schematic of the chassis intrusion detector is shown in FIG. 8. Power is supplied from an external computer though connection 254 leading to the USB connector 25 of FIG. 3. Connection wire 254 also provides communication from the electronics and sensors assembly of which the security assembly is a part. The fine wire maze is shown at 250, the security assembly (SA) at 251, the long-life battery at 253 and the RAM memory and processor at 252. Security assembly (SA) 251 can be a separate subassembly which is further protected by being potted with a material such that any attempt to obtain access to the wires connecting the battery 253 to the microprocessor and to the RAM memory 252 would be broken during such an attempt. This is a secondary precaution since penetration to the SA 251 should not be possible without destroying the private information.

To summarize, any disruption of the mesh wires in the film will destroy the private key or key generating code and other private information making it impossible to decode the test questions or otherwise operate the monitor. After the assembly of the device 20 is completed, the microprocessor can be powered on and the first step can be to measure the inductance, resistance, and capacitance, as appropriate, of the mesh of wires 35, 36. If any of these measurements significantly change, for example above or below a threshold, the circuit in the SA 251 would remove power from the RAM memory 252 thereby destroying the private information. Since the private information cannot be reloaded, the assembly would need to be returned to the factory for remanufacture and the insertion of a new SA 251 or entire electronics and sensors assembly or other remanufacturing step or process.

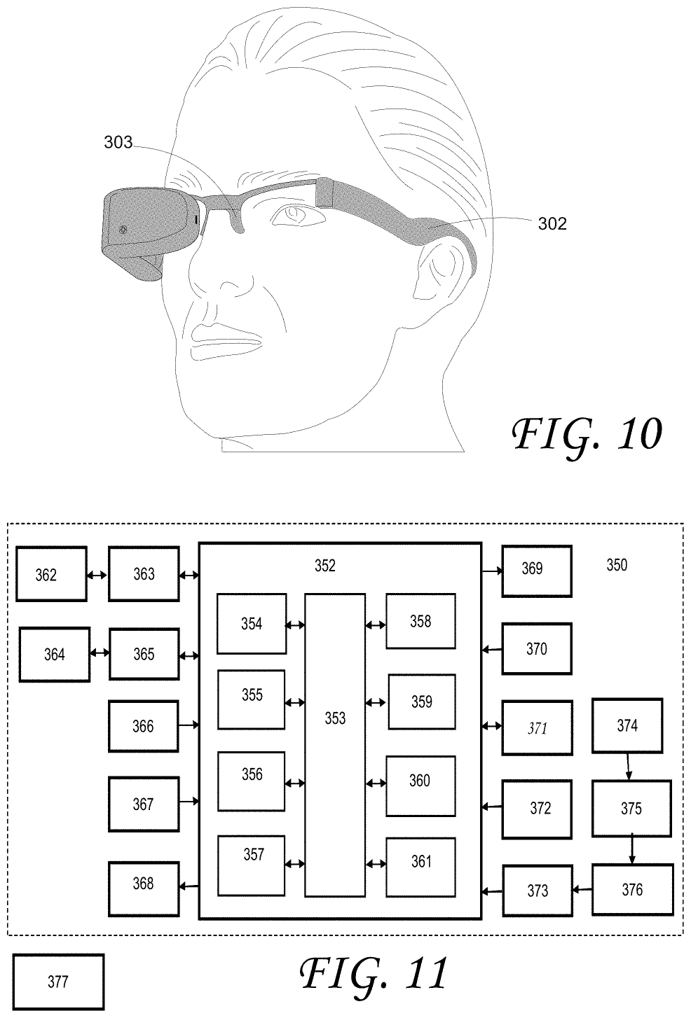

FIGS. 9 and 10 show another version of a monitor, device 300 with a frame 301 on the person without lenses. A USB connector may snap into a housing 305 before the housing 305 is closed. A variant of the nose pad 303 and temple 302 are shown in FIG. 10.

4. Display Optical Analysis

FIG. 19 illustrates an optics detail showing one monitor implementation including a method of nearsightedness and farsightedness adjustment and nose rest adjustment.

FIG. 19 shows details of one possible version of the display optics used in the monitor 20, or any other monitor disclosed herein, and unless specifically addressed, are common optical components whose function is known or readily ascertainable by those skilled in the art to which this invention pertains. Other preferred designs are presented below.

Adjustment for nearsightedness and farsightedness can be accomplished, for example, through moving a display 800 or a lens 807, both of which are covered by the CID, as display 27 is covered by CID 22. If the position of the display 800 is used, then it should be positioned during assembly and prior to the application of the CID 22 or an adjustment mechanism would have to protrude through the CID 22. In the former case, the devices would need to be manufactured fitting different test-takers which would thus require several categories of devices to be stockpiled and it would also limit the general use of monitor 20 by several test-takers. If an adjustment mechanism is provided, the integrity of the CID 22 is compromised which may allow a path to the inside of the device where the contents of the display 800, for example are captured and transmitted to the consultant.

In the second case, the lens 807 can be left outside of the CID 22 making it easy to use for eyesight adjustment. In this case, however, the focal point of the iris camera would also change since it goes through the same lens. A self-focusing camera could be used for the iris camera to solve this problem or a lens system with a high f-stop yielding a long focal distance could be used. Alternately, the iris camera can be placed such that it does not go through the lens 807 by placing it below or to the side of the display optics.

In FIG. 19:

800 is a display panel with integral illumination;

801 is a lens assembly;

802 is an LED to illuminate the iris;

803 is a mirror surface (reflective coating);

804 is an iris camera (including a projection-type lens and an image sensor);

805 is an absorbing coating on the side of the beam-splitter cube (not obligatory, helps to increase the image contrast);

806 is a beam-splitter cube;

807 is a main lens;

808 is the device-to-eye distance (the working distance);

809 is an iris;

810 is a crystalline lens within the eyeball;

811 is a retina;

812 is an observer's eye (an eyeball or a sclera).

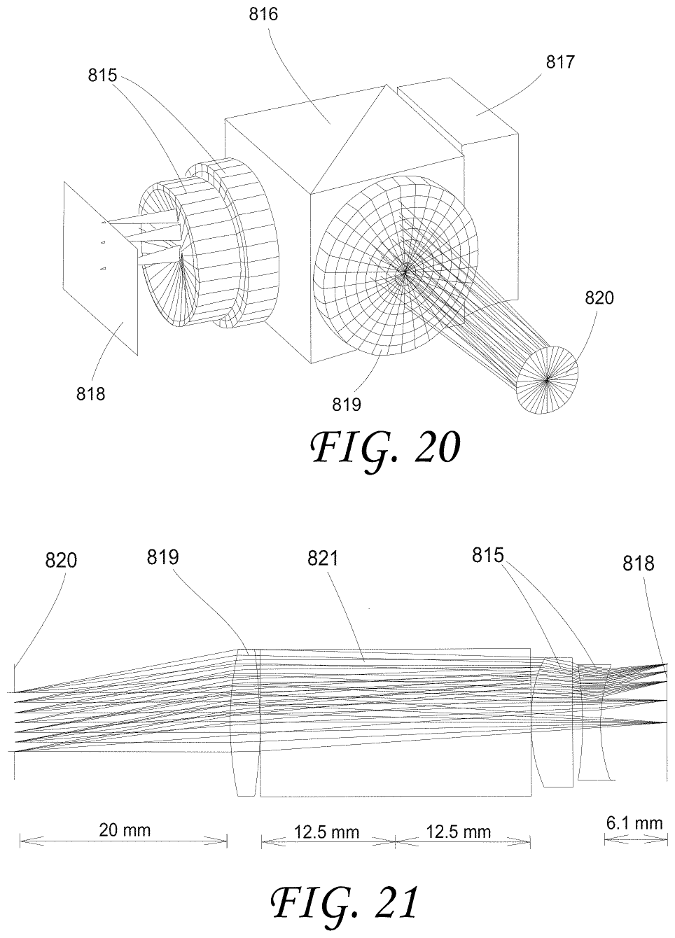

FIG. 20 is a 3D computer generated diagram of the display and iris-scanner module. The LED is not shown here. It is arranged along the axis lens 819 at the opposite plane of the cube beamsplitter, see FIG. 19.

In FIG. 20:

815 is a lens component;

816 is a beam-splitter cube

817 is an iris camera;

818 is a display panel;

819 is a main lens;

820 is an entrance pupil of the eye.

FIG. 21 shows a ray path in the display channel shown at a linearized in the reverse direction.

In FIG. 21:

815 is a lens component;

818 is a display panel;

819 is a main lens;

820 is an entrance pupil of the eye.

821 is a beam-splitter cube (here the full ray path is shown).

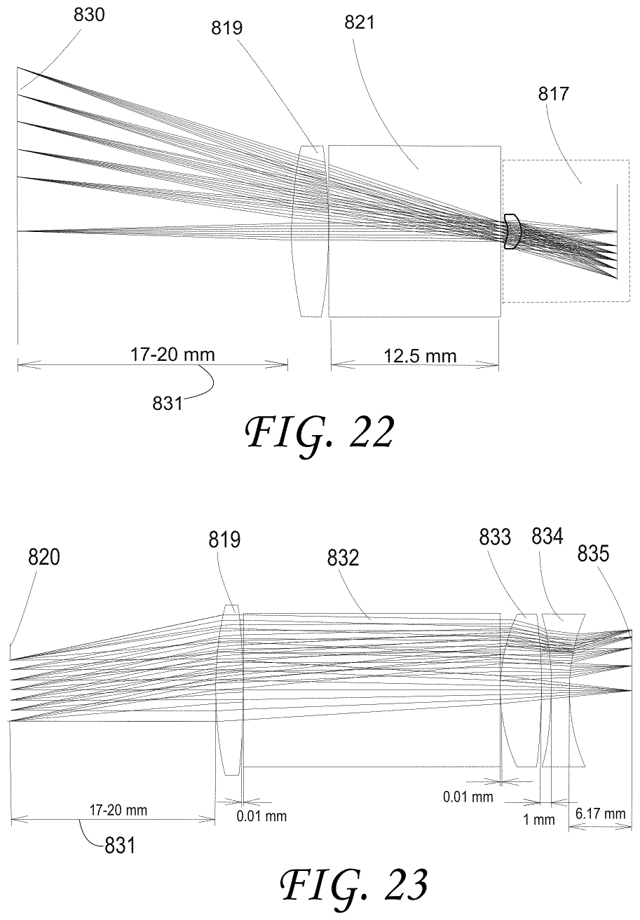

FIG. 22 shows the ray path in the iris-scan channel shown at a linearized scheme in the forward direction.

In FIG. 22:

817 is an iris camera (including a projection-type lens and an image sensor);

819 is a main lens;

821 is a beam-splitter cube;

830 is a linear field of view of the iris camera (a plane of the iris)

831 is a device-to-iris distance.

FIG. 23 shows lens prescription data, and Table 1 shows characteristics of different lens considered for use in any of the monitors disclosed herein.

TABLE 1

| | First | Second | Thick- | | Light zone | Lens |
|---|---|---|---|---|---|---|
| Lens | radius, | radius, | ness, | | Diameter, | Diameter, |
| # | mm | mm | mm | Glass | mm | mm |
| 1 | 25.726 | −50.16 | 2.7 | N-PK51 | 12.5 | 14 |
| 2 | 12.75 | −44.508 | 4 | N-PSK53 | 11 | 12.5 |
| 3 | −21.428 | 13.046 | 1.7 | N-SF4 | 10 | 12.5 |

In FIG. 23:

819 is a main lens;

820 is an entrance pupil of the eye;

832 is a beam-splitter cube (here the full ray path is shown);

833 is a positive lens of the lens component;

834 is a negative lens of the lens component;

835 is a display panel.

5. Biometrics

Biometrics are used herein to ascertain the identity of the test-taker. The main biometric used is the iris, retinal or face portion pattern. Other biometrics which can be used to augment the main biometric include the heartbeat pattern, EKG pattern, and voice print.

6. Cameras and Lenses

The preferred cameras and lenses used herein are sensitive to IR although white light sensitive cameras can also be used as can cameras which are sensitive to both parts of the electromagnetic spectrum.

7. Cryptography

Standard high bit PNG cryptographic technology is used herein involving although other technologies can be used. The technology is based on public/private key sets.

8. Classification

The classification of images from the cameras, voiceprints, EKG images, heartbeat graphs etc is done using neural networks or deep learning algorithms although other classification systems can be used.

9. Smartglasses

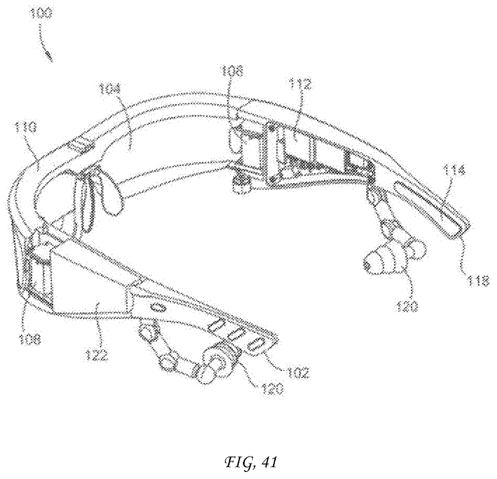

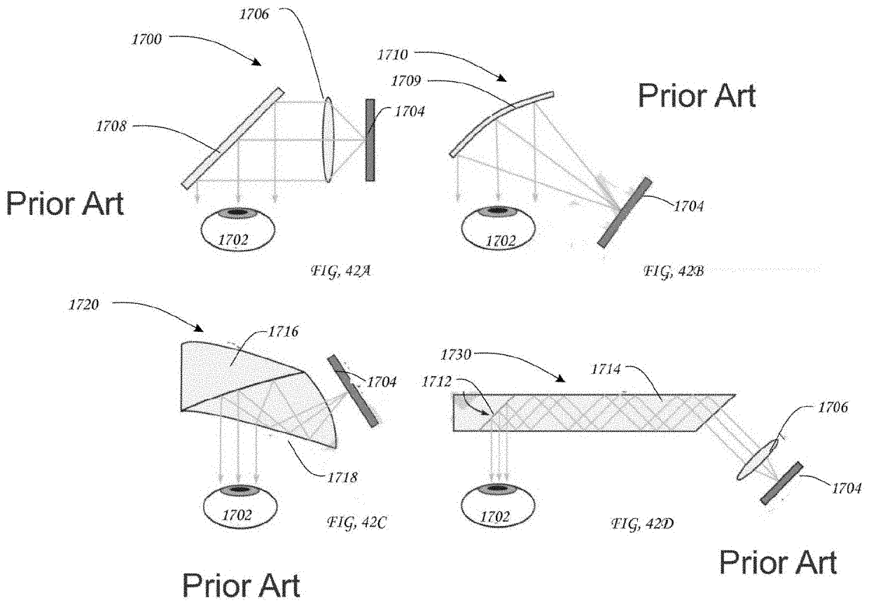

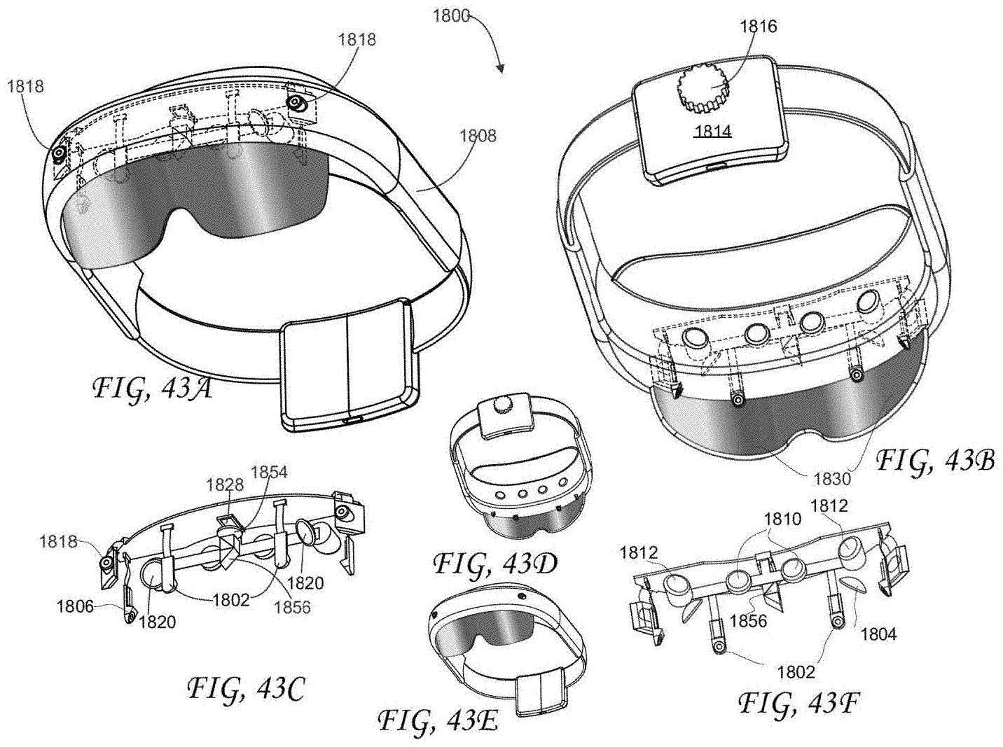

An alternate monitor 1800 which provides an image to both eyes using a single microdisplay is illustrated in FIGS. 43A-43F. In this design, the components, which must be protected by the CID not shown, are more closely arranged to simplify the CID design. A single (micro)display 1828 is used to illuminate lenses 1830 seen by each eye. Two iris cameras 1802, two crossview cameras 1806, and two forward cameras 1818 can be implemented in this design (the iris cameras 1802 and crossview cameras 1806 being considered a presence and/or position-determining camera system and the forward cameras 1818 being considered a forward-looking camera system for this embodiment and other disclosed embodiments). Since the display 1828 will be seen by both eyes, i.e., there is a common display whose contents are projected to both eyes, both eyes must be monitored to guarantee that the monitor 1800 has not been rotated or in some manner pulled away from either eye to permit a foreign camera to be inserted. The crossview cameras 1806 similarly must now watch both sides of the test-taker's head to search for nefarious cameras inserted by the test-taker.

Sensor assemblies 1810 and 1812 are provided on each side of the forehead (see FIG. 43F). These sensor assemblies 1810, 1812 measure the EKG and sound emitted by the test-taker's head. Sensor assembly 1810, for example, can contain a contact speaker and contact microphone, one in each sensor. Similarly, sensor assembly 1812 can contain an ECG (EKG) sensor. The contact microphone will determine when the test-taker is emitting sounds and the contact speaker will be used to test that the contact microphone is in contact with the test-taker's skin, as described in the other monitor examples. The contact speaker can also emit an audio sound and thus can be used to test the audio speaker, not shown, if present. Since the EKG sensor pads must be sensitive to very low voltages, they generally will be placed on the outside of the CID.

A small pair of contacts can be placed in the CID to permit signals to be passed from the EKG sensors to the interior electronics. The EKG sensor pads can be appropriately attached to the CID by gluing in such a manner that any attempt to remove the EKG pads will destroy the CID.

Two forward or front view cameras 1818 are provided in order to increase the field of view of the sensor system and to permit future 3D images to be created when augmented reality is implemented into this design. Although not shown, the optical system can be arranged such that alternately polarized frames can be fed to the right and left eyes of the test-taker, wherein the single display panel can pass the information to the eyes to permit 3D holographic viewing by selectively polarizing successive frames or even in the same frame.

Monitor 1800 includes a frame that is constructed to enable securing or mounting of a front section to the head of the wearer, and specifically in front of and above the forehead of the wearer. Different positions of the front section are possible but it is necessary to create an optical path from the display 1828 to the lenses 1830. The lenses 1830 include an at least partially reflective surface which is thus below the display 1828 to cause formation of this optical path downward from the display 1828 to the at least partially reflective surface of the lenses 1830 (forming a combiner) and also rearward from the at least partially reflective surface of the lenses 1830 to the eyes of the person when the frame is on the person's head. The at least partially reflective surface has a state in which it reflects content of the display 1828, when present, to at least one of the person's eyes when the frame is on the person's head while allowing viewing by the person of an environment in front of the person through the at least partially reflective surface such that the person simultaneously views, through the at least partially reflective surface, content on the display 1828 being reflected by the at least partially reflective surface of the lenses 1830 and the environment in front of the person.

A space is present below the display to facilitate the optical path. This space is in front of the person's eyes, below the display 1828 and above the lenses 1830.

Lenses 1830 are angled relative to the display 1828 to ensure that content being reflected by the lenses 1830 is reflected to the eyes of the person when the frame is correctly mounted on the person. One skilled in the art to which this invention pertains would be able to determine this angular orientation. Moreover, this angular orientation will enable the person to see through the lenses 1830 and view to ambient environment.

The monitor 1800 in this example contains a headband 1808 with an adjustment knob 1816 to permit the monitor 1800 to be securely mounted to the test-taker's head (See FIG. 43B). A battery 1814 can also be integrated with the device and placed at the rear of the device to balance the forces from the monitor 1800 on the head of the test-taker. In this manner, the center of gravity of the monitor 1800 can be adjusted to be placed near the center of the test-taker's head. Under these circumstances, there should be little tendency for the monitor 1800 to slip forward or backward. The battery 1814 now can be considerably larger than in previous designs and designed to provide many hours of operation without an external power source. A wire, not shown, can lead from the battery 1814 to a wall charger or, alternately, a receptacle can be provided in the battery case for that purpose.

The display panel 1828 projects downward through lenses 1854 to a polarizing beamsplitter and mirror assembly 1856 which sends alternately polarized light to the left and to the right. Thus, the display image is split into two images alternately polarized. Birdbath mirrors 1820 then project the light down toward the lenses, or combiners, 1804 which contain reflecting surfaces and reflect the light into the eyes. Each lens 1854 can be differently polarized so that the light which is polarized horizontally for the right eye, for example, interacts with a vertically polarized film on the right lens. This has the effect of making the right lens act as a mirror preventing the image from being seen from in front of the monitor 1800. Similarly, the polarized image for the left eye which can be polarized vertically, for example, would interact with a horizontally polarized film for the left eye. Rather than polarizing vertically and horizontally, naturally polarized light from the environment will have less effect if the polarization angles are +45 degrees and −45 degrees.

In an alternate arrangement, not shown, the light from the projectors will project to the rear of the device to locations on either side of the head where a mirror, such as a birdbath mirror would change the direction of the image and project it toward the polarized lenses for viewing by the test-taker. This method simplifies the design of the lenses eliminating the need for reflective surfaces to change the angle of the light to be integrated into the lenses.

Several adjustments which are not shown will now be described. An adjustment of the projector angles, or the mirrors that reflect the image to the lenses, can be used to accurately aim the reflections into the test-taker's eyes thereby accommodating any variance in the inter-pupil distance for different people. The lenses can be a compound lens arrangement whereby the outer lens corrects for prescription lens as needed for people with different requirements. The inner lens can be the one from which the reflections to the eyes are made. These two sets of lenses can be designed so that the outer lenses are interchangeable depending on the visual needs of the test-taker. The inner lens can be incorporated within the CID thus eliminating the possibility of a test-taker placing a camera that could see the inner lens and thus the display. The focus of the display can be changed by moving the various optical components. Under this arrangement, the field of view can be controlled so that it can only be seen by the test-taker's eyes.

In this monitor design, provision can be made for augmented reality devices such as a virtual smartphone, mouse or keyboard for use by the test-taker. These can require that the fingers of the test-taker be recognized and mapped in such a way that the motion of the fingers can be accurately tracked and understood. The virtual keyboard can be attached to a location near the test-taker's fingers or to a table that is either virtual or appears in the environment.

The arrangement in this design also lends itself for holographic presentations.

Another embodiment of the monitor 1800 may be considered independent of the headband 1808. As such, it would comprise a housing including the various cameras and optical components and structure to enable attachment to the head of the person. Such structure may be any known structure including but not limited to a headband. The housing does not cover the head of the user but rather is designed to rest upon the forehead of the user or be supported partly in front of and forward of the user's eyes and face.

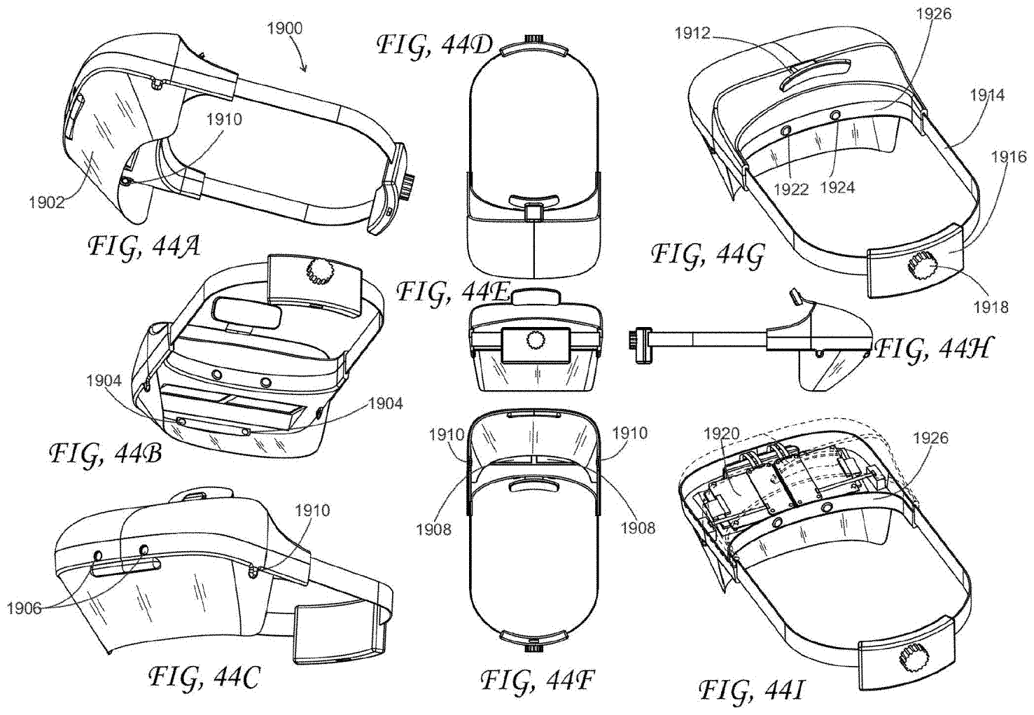

FIGS. 44A-44I illustrate another preferred design of the monitor 1900 for two eyes, in this case utilizing two larger displays 1908 forming a display section in a housing of the monitor 1900. Two displays 1908 are positioned approximately horizontally in the monitor 1900 alongside one another as shown in FIG. 44F. Images from the displays 1908 reflect off a combiner 1902. The combiner 1902 preferably has a semi-reflective coating on the inside surface, i.e., that surface in the optical path between the display 1908 and the eyes of the test-taker, which reflects only a percentage, for example 50%, of the incident light from the displays 1908 toward the test-taker's eyes (the test-taker being the person on whose head the monitor 1900 is supported) when the monitor 1900 is placed or otherwise situated on the test-taker's head. The balance of the light is passed vertically downward.

The combiner 1902 allows the test-taker to simultaneously view the environment, since the combiner 1902 is positioned on the frame or housing of the monitor 1900 to be in front of the test-taker's eyes when the monitor 1900 is on the test-taker's head, as well as reflection of content from the displays 1908. The combiner 1902 therefore does not block out all of the light from the environment in front of the test-taker, in contrast to some virtual reality goggles that entirely cover the eyes of the wearer and prevent the wearer from seeing outside of the device. Also, the combiner 1902 does not have to contact or conform to the shape of the wearer's face at the bottom edge and so there is often a gap between the bottom edge of the combiner 1902 and the person's face.

The combiner 1902 preferably has an antireflective coating on the outside surface to potentially allow the maximum light to pass through the combiner 1902 from the environment. The combiner 1902 can also have a privacy film which prevents light from being seen from outside except in a direction approximately perpendicular to the surface of the combiner 1902. Such a film thus blocks the light which normally passes through the combiner 1902 in the vertical direction and could thus otherwise be seen from below. The combiner 1902 represents a singular combiner or multiple combiners that cooperate to provide the functionality described above. An upper edge region of the combiner 1902 is attached to the frame or housing of the monitor 1900 so that the combiner 1902 is below the frame. Also, the combiner 1902 and frame or housing are components of a front portion of the monitor 1900. The edges of the front portion are not configured to conform to the face of a wearer. In addition to a front portion designed to be at least partly in front of the eyes of the test-taker when the monitor 1900 is on the test-taker's head, the combiner 1902 may also be provided with side sections, one on each side of the front section. As such, the person can see in front of them or to the sides only through the combiner 1902 and its associated structure.

The displays 1908 themselves can also have privacy films attached to their surfaces to accurately direct the light in a direction perpendicular to the display surface making it difficult to see the display 1908 from below. Privacy films generally work best in preventing light transmission in the horizontal or vertical directions and therefore two such films may be required for the displays. The combiner can also comprise a film of electrochromic material whose transmissivity can be electrically controlled. Thus, the amount of light passing through the combiner from the environment can thus be controlled. This permits the view of the reflected image from the combiners under conditions of bright ambient light. Alternates to electrochromic material include Kerr cells. Finally, as discussed below, the crossview cameras 1910 are provided to monitor the space surrounding and below the combiner to search for unwanted cameras.

Two iris cameras 1904 are provided to monitor the irises of the test-taker to make sure that the eyes of the test-taker are in the proper position during test taking while the display is illuminated, and the monitor 1900 is on the test-taker's head. The cameras 1904 are also used for biometric identification purposes. The iris cameras 1904 can have a much wider field of view than necessary to observe the iris and thus they can also be used to monitor for hidden cameras placed by an test-taker to transfer the contents of the test to an accomplice. Iris cameras 1904 are part of an iris camera system arranged on the frame of the monitor 1900 and which is generally configured to image the left and right eyes of the test-taker when the monitor 1900 is on the test-taker's head. The iris camera system may include a different number of iris cameras 1904, so long as the left and right eyes are imaged. The iris camera system is arranged on the front portion of the monitor 1900.

Crossview cameras 1910 are provided to monitor the volume between the displays, combiner and eyes of the test-taker (test-taker) to check for the placement of hidden cameras to transfer the contents of the test to an accomplice. Through the use of the iris and crossview cameras 1904, 1910, it should not be possible to hide an imaging device within the volume encompassed by the monitor 1900 and the face of the test-taker. Crossview cameras 1910 are part of a crossview camera system arranged on the frame of the monitor 1900 and which is generally configured to image from a location on a first lateral side of the frame toward a second lateral side of the frame opposite the first lateral side and below the combiner, and image from a location on the second lateral side of the frame toward the first lateral side of the frame and below the combiner when the monitor 1900 is on the test-taker's head. The crossview camera system may include a different number of crossview cameras 1910, so long as the volume encompassed by the monitor 1900 and the face of the test-taker is imaged. The crossview camera system is arranged on the front portion of the monitor 1900.

Two forward-looking cameras 1906 are also provided for monitoring the environment surrounding the monitor 1900 and test-taker. These cameras 1906, which together will encompass a large field of view, can be used to monitor for the existence of notes, textbooks, or other apparatus which could aid the test-taker in answering the test questions, but which are prohibited by the rules of the test. The existence of a computer which the test-taker could use to access the Internet can be determined. Similarly, if the test-taker is typing on a keyboard, that action can be detected. In short, the forward-looking cameras 1906 can detect any forbidden activity undertaken by the test-taker. They can also determine the presence of potential accomplices trying to help the test-taker during the test taking process. The forward cameras 1906 can be provided with LED or other illumination which can be in the visual or infrared (IR) portion of the electromagnetic spectrum. The cameras 1906 need to be sensitive to IR if IR illumination is used. Forward-looking cameras 1906 are part of a forward looking camera system arranged on the frame of the monitor 1900 and which is generally configured to image an area in front of the frame, and ideally to the outward sides of the frame when the monitor 1900 is on the test-taker's head. The forward looking camera system may include a different number of forward looking cameras 1906, so long as the environment around the monitor 1900 is are imaged. The forward looking camera system is arranged on the front portion of the monitor 1900.

The images obtained by the six cameras discussed above, may be analyzed using trained neural networks or Deep Learning technology, for example. To this end, a processor is provided on the monitor 1900, usually in the front portion or housing (e.g., including or on printed circuit board 1920 shown in FIG. 44I). This processor is coupled to the cross-view camera system, the iris camera system and the forward looking camera system and performs various image analysis. For example, the processor, analyzes images obtained by the cross-view camera system to determine presence of imaging devices in any obtained images, analyzes images obtained by the iris camera system to determine position of irises of the test-taker on which the monitor 1900 is situated (and optionally imaging devices), and analyzes images obtained by the forward-looking camera system to determine presence of specific objects. The processor may also be configured to analyze images obtained by the iris camera system and perform a biometric identification, based on the image analysis and previously obtained biometric data. Generally, the processor can use pattern recognition when analyzing images, or be otherwise trained, programmed or configured to provide the desired output of the presence of or lack of imaging devices in images. When used for testing purposes, determination of the presence of an imaging device, or person, or unauthorized testing aid or person, can result in the test being terminated. The processor for image analysis as described above is assumed to be located on the monitor. Alternately one or more of the processing functions can be accomplished on a server to reduce the computational load on the monitor processor.

The monitor 1900 is held in position on the test-taker's head by means of forehead resting pad 1912 coupled with an elongate band 1914 which is preferably adjustable for tension by adjustment knob 1918 (see FIG. 44G). Band 1914 is connected at one end to the front portion of the monitor 1900 and also connected at the opposite end to the front portion of the monitor 1900. Other bands and length adjustment mechanisms may be used in the invention. Another elongate band 1926, which holds the contact microphone 1922 and contact speaker 1924 in position against the forehead of the test-taker, also contributes to the proper positioning of the monitor on the head of the test-taker. Band 1926 is part of the front portion of the monitor 1900. As shown in FIG. 44G, the contact microphone 1922 and the contact speaker 1924 are spaced apart from one another on the band 1926.

The electronic printed circuit boards are illustrated generally at 1920 and are powered by a battery 1916 through wires which are not illustrated. Printed circuit board 1920 should be considered to represent a processor or processor means or data processor used for performing the functions need for operability of the monitor 1900, including but not limited to the image analysis. Monitor 1900 may include additional features, including those features of any embodiments of a monitor or glasses disclosed herein. Use of the monitor 1900 may be testing purposes in any of the ways disclosed herein.

An apparatus in accordance with the invention includes a housing that is configured to be mounted in front of the person, with its rear central portion being the forehead resting pad 1912. The housing forward of the forehead resting pad 1912 includes, for example, the combiner 1902, the iris cameras 1904, the forward-looking cameras 1906, the displays 1908, the crossview cameras 1910 and the printed circuit board 1920. Instead of the band 1914, other structure to secure the housing to the person with the combiner 1902 in front of the eyes of the person, may be used in the invention.

Monitors 1800, 1900 can be used in a variety of different ways to provide for secure testing, that is, testing with an almost certain guarantee of cheating prevention. In an exemplifying method, images obtained by the cameras on the housing of the monitors 1800, 1900 is processed using pattern recognition. Analysis of images obtained by the crossview camera system is undertaken in this manner to determine presence of imaging devices in any obtained images, and similarly images obtained by the iris camera system are analyzed to determine position of irises of the person on which the housing is situated, and images obtained by the forward-looking camera system are analyzed to determine presence of specific objects that may be indicative of cheating. Such pattern recognition may be performed by a processor in the housing or a processor remote and separate from the housing, e.g., at a central location which is wirelessly connected to the monitor 1800, 1900 or a plurality of such monitors 1800, 1900.

There may be a central processing site with one or more processors and telecommunications equipment that receives images from the cameras on the monitors 1800, 1900 and performs processing using pattern recognition. By providing processing in this manner, it becomes easier to update the processing when, for example, a new method of cheating is invented or a new cheating device is invented. One re-programming of the pattern recognition algorithm being used by the processor at the central site would be sufficient to enable analysis of images from a plurality of physically separated monitors 1800, 1900 providing images to the central site via telecommunications equipment. This central site may be in the cloud on a dedicated server maintained by an entity that manages use of the monitors 1800, 1900 as a form of cloud-based computing. A processor that performs the image analysis, and other functions needed by the monitor 1800, 1900 may thus be separate and apart from the frame, but in communication with any hardware on the frame by known telecommunications equipment.

Multiple processors may also be used, whether on the monitor 1800, 1900, at a central site, at a smartphone coupled to the monitor 1800, 1900, or a combination thereof.

Although monitors 1800, 1900 include specific cameras, it is also possible to install cameras or other imaging devices in a room where testing is to occur with the monitors 1800, 1900. These cameras can also provide images to a processor that can utilize pattern recognition to determine cheating. The processor could be at a remote site and the room cameras provide image via telecommunications equipment.

In monitor 1800, the lenses 1830 have an upper edge portion adjacent the front of the housing of the monitor 1800 and a lower edge portion below the upper edge portion and that is free and unrestrained. There is not required to be any structure below the lower edge portion of the lenses 1830, although a panel may be provided to close off the space defined rearward of the lenses 1830 (and prevent insertion of cheating devices such as cameras). The lower edge portion is more rearward from the front of the housing than the upper edge portion to provide the angled position of the lenses 1830, i.e., the lenses 1830 are angled downward and inward away from the front of the frame and upper edge portion of the lenses 1830 in a rearward direction away from the front of the frame. Display screens in prior art virtual reality glasses are often flat in front of the eyes of the wearer, i.e., without any angular orientation.

Similarly, in monitor 1900, the combiner 1902 has an upper edge portion adjacent the front portion or housing of the monitor 1900 and a lower edge portion that is free and unrestrained. There is not required to be any structure below the lower edge portion of the combiner 1902, although a panel may be provided to close off the space defined rearward of the combiner 1902. The lower edge portion of the combiner 1902 is more rearward from the front of the housing than the upper edge of the combiner 1902 to provide the angled position of the combiner 1902 i.e., the combiner 1902 is angled downward and inward away from the front of the frame and upper edge portion of the combiner 1920 in a rearward direction away from the front of the frame (best seen in FIG. 44A).

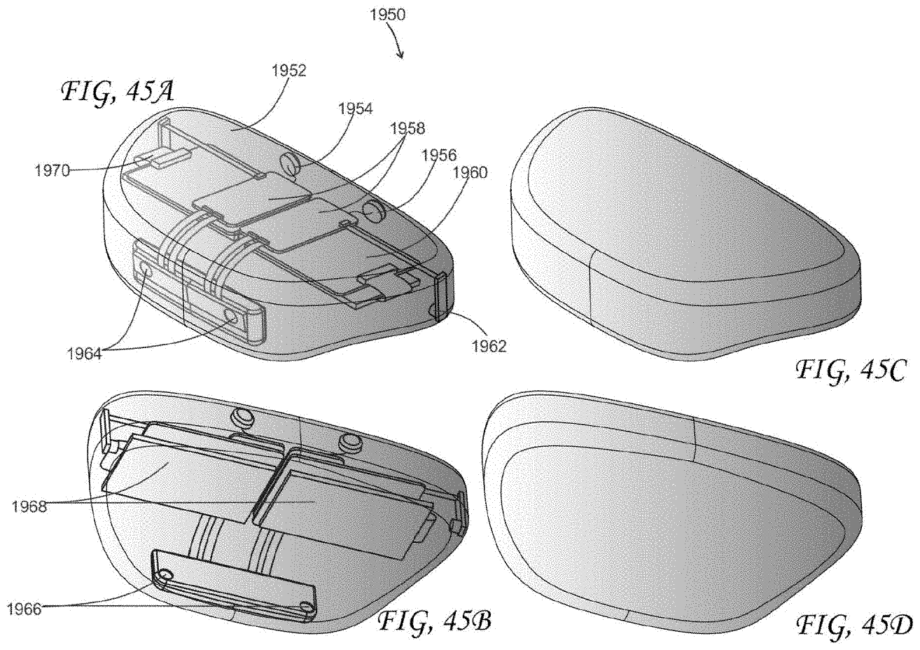

FIGS. 45A-45D illustrate key components of the monitors 1800, 1900 as covered with the chassis intrusion detector (CID) 1952. The operation the CID is discussed elsewhere and will not be repeated here. The assembly covered by the CID is shown generally at 1950.

In FIGS. 45A-45D within the CID 1952, there is a contact microphone 1954, contact speaker 1956, interfaces 1958 between the forward and iris cameras with a PC board 1960, cross-view cameras 1962, forward cameras 1964, and iris cameras 1966. Displays 1968 are connected to the PCB board 1960 by ribbon cables 1970.

As shown, the CID 1952 is represented by a smooth envelope. In practice, the CID 1952 will adhere to the surfaces of the various components. In some cases, it will be necessary to add additional structure to position the CID 1952 properly relative to the various components that it is meant to protect. The CID 1952 may be attached directly to the cameras 1962, 1964, 1966 and displays 1968 in such a way as to provide a smooth surface that does not distort the images being acquired or displayed by these devices. The CID 1952 preferably covers just what is shown in FIGS. 45A and 45B. The CID 1952 does not cover the side shield (a portion of the combiner 1902) or the band 1914. In practice, the intrusion protected device may be formed by covering the front portion or housing, and its associated cameras, with the CID 1952 and then snapping it into a frame with a wire coming out from this covered device going to a battery and a receptacle on the battery for connecting to the wall power.

Assembly 1950 may be considered a unit mountable in front of and above the person's eyes to enable the downward optical path from the display to the combiner and rearward optical path from the combiner to the eyes of the user. An important feature of some of the embodiments of the monitors 1800, 1900 including assembly 1950 is that they do not enclose a space in front of the eyes of a person when the monitor 1800, 1900 is worn and prevent the person from viewing the ambient environment. Rather, the person can view through the lenses 1830 or combiner 1902 at some times, and view test questions or other testing material.

Using the monitor 1800, 1900, a test is conducted in accordance with the invention by causing display of test questions on the display which are reflected to the combiner and then visible to the test-taker. An area rearward of the combiner is imaged using a presence and/or position-determining camera system which may but is not required to be on the frame, and an area in front of the frame using a forward-looking camera system which may but is not required to be on the frame. Imagers can thus be entirely on the frame, partly on the frame, or entirely on structure of a room or other facility where the text is taking place.

A processing system at least partly separate and apart from the frame, analyzes the images obtained by the presence and/or position-determining camera system to determine presence of imaging devices in any obtained images and/or position of an iris of each of the at least one left and right eye of the person on which the frame is situated. The former would indicate cheating using the extraneous imaging devices and the latter, a change in the test-taker. The processing system also analyzes images obtained by a forward-looking camera system to determine presence of cheat-aiding objects, whether cameras or people.

The test is stopped when imaging devices are determined to be present in any obtained images, when the position of an iris of each of the at least one left and right eye of the person changes or when a cheat-aiding object is determined to be present.

Image analysis may entail transmitting the images to the cloud and performing the image processing in the cloud. Image analysis is thus not restricted to only being performed by a processor on the frame, but may be performed entirely or partly by a processor on a smartphone, or a processor in the cloud on a dedicated server. Pattern recognition may be used when analyzing images.

Considering the frame to have a front and a rear, the frame may be secured on or against the test-taker's head with the rear closer to the person's head. The combiner 1902 can thus have an upper edge portion adjacent the front of the frame and a lower edge portion below the upper edge portion and angled away from the frame in a rearward direction away from the front of the frame (see FIG. 44C).

As noted above, the combiner is configured to allow for viewing of the combiner by the test-taker, whose eyes are on one side of the combiner, an environment on an opposite side of the combiner and thus viewing of the environment through the combiner, and for viewing of content being reflected onto the combiner. To achieve this, the combiner is provided with an at least partially reflective surface below the display to cause formation of an optical path downward from the display to the at least partially reflective surface of the combiner and rearward from the at least partially reflective surface of the combiner to the right and left eyes of the test-taker when the monitor 1800, 1900 is on the test-taker's head. The at least partially reflective surface has a state in which it reflects content of the display, when present, to at least one of the test-taker's eyes while allowing viewing by the test-taker of an environment in front of the test-taker through the at least partially reflective surface such that the test-taker simultaneously views, through the at least partially reflective surface, content on the display being reflected by the at least partially reflective surface of the combiner and the environment in front of the test-taker.

10. Gestures

Forward monitoring cameras can be used to monitor positions and motions of the test-taker's hands and fingers and thus can be used to record gestures. The gestures can be used to control various functions of the monitor. Gestures, for example, can be used to control information displayed on the displays and for selecting the answers in multiple choice tests. Gestures can replace touch screen functions, for example. In many cases, for example, the motions of the hands and fingers can replace a mouse or keyboard, further improving the security and versatility of the monitor. A virtual mouse and/or keyboard can be provided for such uses.

11. Health Monitoring

Various sensors including the iris camera, microphone, skin temperature, EKG, heartbeat and blood flow etc. can be used to monitor various health related parameters. The EKG, for example, can monitor for skipped beats and arrythmia and the information forwarded to the SecureTest server or any other Internet server as desired.

12. Processor

The various sensors do not all need to be continuously monitored. Once the iris image has been acquired, additional images of the eye can be acquired once per second or at some other rate which makes little use of the processor requirements. Initial models of the monitor have used the Raspberry Pi 0W and CM3 boards or later models with their resident processors.

13. Sensors

Many additional sensors can be mounted to the monitor such as fingerprint sensors, touch sensors etc. Additionally, many other sensors that are not integral to the monitor can communicate with the monitor through WiFi, Bluetooth or other wireless or wired communication protocols. In some implementations, for example, it may be desired to have one or more cameras located in the environment, such as a laptop camera, to monitor the activities of the test-taker or in the environment while a test is underway or at other times. Similarly, the monitor can be used to control off monitor devices such as room temperature, lights, garage door, door locks etc through its connection to the Internet or to another external controller.

14. Communications

Communication from the monitor to the Internet and other devices generally involves use of Wi-Fi and Bluetooth™. Communication generally can involve the sending of test questions and answers between the monitor and an Internet resident server. In some versions of the monitor, direct cellphone communication will also be available. This will become increasingly important as cellphone data transmission speeds increase. The best method of communicating with the Internet may soon be through 5G and thus Wi-Fi, although available, may be used less and less. The CID provides excellent hardware security, but the possibility still exists for software malware to enter the monitor through one of the communication channels. One method of guarding against such malware becoming resident on the monitor is to require that all communications other than Bluetooth™ with the monitor take place through a secure Internet resident server. This server would scan all transmissions intended for the monitor to make sure that no malware is present.

When using the monitor, it may be desirable to use the computational resources of external devices such as smart phones and PC computers. This can be accomplished using various input methods to send data and commands to the external device. These methods include using a physical or virtual mouse and or keyboard or orally. For some special applications, alternative data input devices may be utilized with the monitor providing the proper software and hardware is provided. One such device is a clicker which can be used to answer multiple choice questions. Another is a ring that has many of the functions of a mouse but resides on the finger of the test-taker. Such a ring, in some cases, can have a camera which can be useful for taking a picture of the test-taker to help in verifying his or her identity. As with cell phones, the monitor can also be used to control external devices such as radio or TV stations, lights, door locks, etc as already mentioned.

15. Alternative Designs

Above in FIGS. 1-10, for example, a simple direct projection display has been illustrated where the display is in the form of a projector directing the image directly into the eye. Alternative reflection displays have also been disclosed. The direct projection display has the disadvantage of blocking a view of the surrounding environment when the image is not being viewed. Similarly, this design is usually limited to implementation for a single eye.

Other options, some also disclosed above, include reflective displays, where the projector sends the image directly toward a lens or combiner in front of the eye, and waveguide displays, where the maximum freedom is provided for the location of the display device relative to the eyes.

Both the reflection and the waveguide displays require a display element that displays the image for further processing by the optical system. Preferred technologies include Liquid Crystal on Silicon (LCoS) and Active Matrix Organic Light Emitting Diodes (AMOLED) or simply LCD displays.

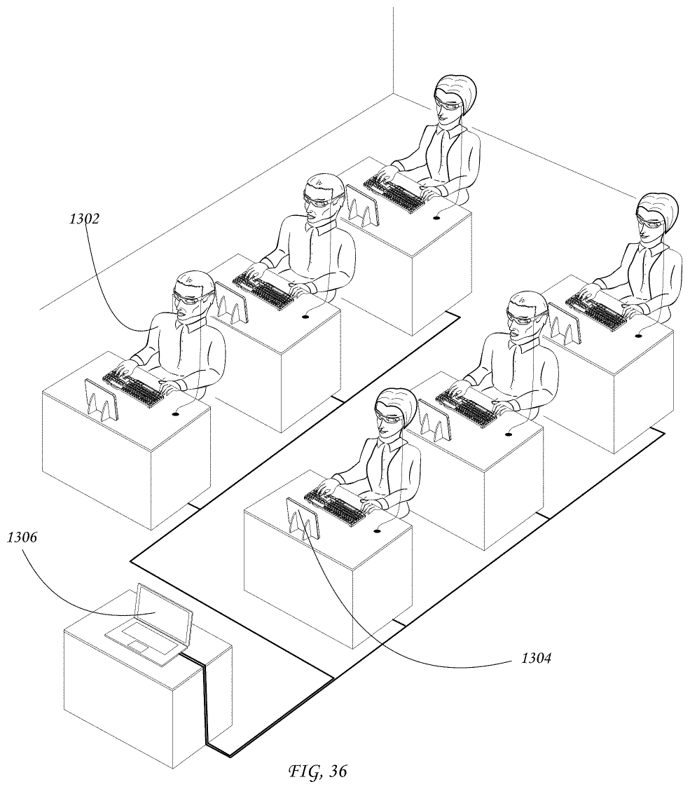

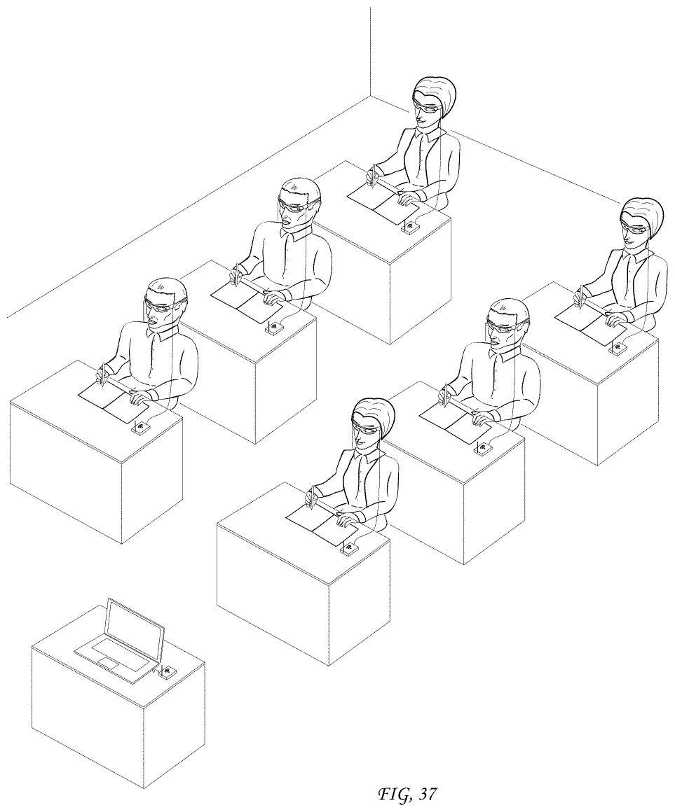

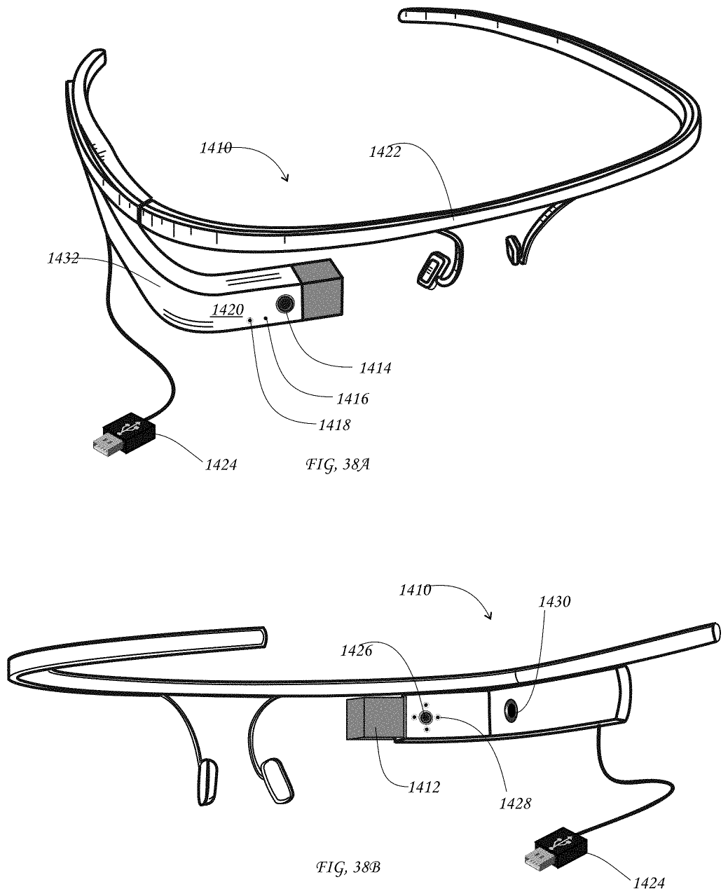

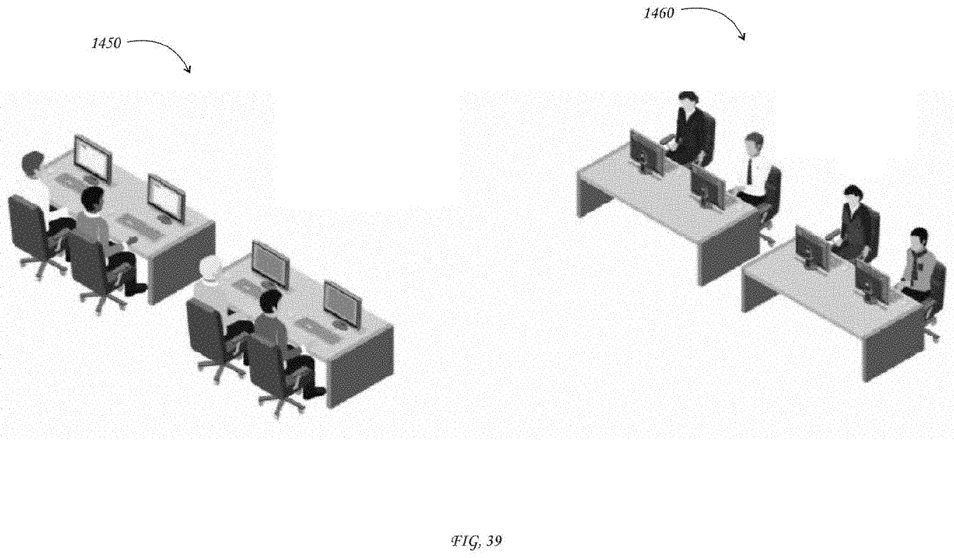

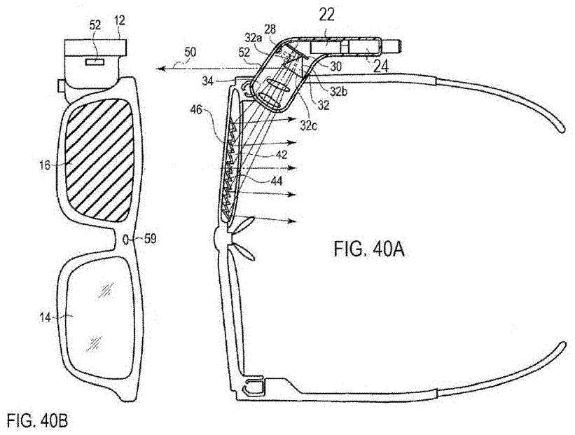

FIGS. 40A and 40B illustrate a preferred design of a monitor using a reflector display taken from US Pat. Appln. No. 20170061212, FIGS. 2A and 2B. This prior art is incorporated by reference in its entirety. The call-out numbers on these figures refer to the disclosure in the 20170061212 patent application. This basic reflector design can be modified to incorporate the CID, iris, forward and crossview cameras, contact microphone and speakers, EKG sensor and other features disclosed herein. It is included here as an example of the use of another reflector display. Another prior art reflector design is disclosed in US Pat. Appln. No. 20170336634.

FIG. 41 illustrates a preferred design of a monitor using a waveguide display taken from U.S. Pat. No. 10,180,572, FIG. 1. This prior art is incorporated by reference in its entirety. This basic waveguide design can be modified to incorporate the CID, iris, forward and crossview cameras, contact microphone and speakers, EKG sensor and other features disclosed herein. It is included here as an example of the use of a waveguide display. The call-out numbers in FIG. 41 refer to the disclosure in U.S. Pat. No. 10,180,572.

FIG. 42A-42D illustrates common optical designs for see-through near-eye displays. Each diagram shows how the light from one pixel in a display panel propagates through the display optics to create an apparently distant point here at optical infinity. These diagrams were adapted from Computational See-Through Near-Eye Displays, by Andrew S. Maimone, Ph. D. dissertation 2015, University of North Carolina at Chapel Hill.

FIG. 42A is an example of a simple combiner 1700, FIG. 42B of a curved combiner 1710, FIG. 42C of a freeform prism 1720, and FIG. 42D of a waveguide 1730. Any of these optical designs and others can be implemented in the monitor and the inventions disclosed herein are not limited to a particular optical design.

In FIG. 42A, light is emitted from a display panel 1704 and captured by a lens 1706 which passes the light to a beam splitter or a polarized lens 1708 which transmits the light to the eye 1702. In FIG. 42B, the initial lens is eliminated and the partially reflecting lens or combiner 1709 is curved. In FIG. 42C, the lens and reflecting functions are performed by a free form prism 1718 and a see-through corrector is used to correct for the distortion of the freeform prism on light from the environment. Finally, in FIG. 42D, a waveguide 1714 is used in place of the polarized lens. The light is reflected out of the waveguide by reflector 1712 to the eye 1702.

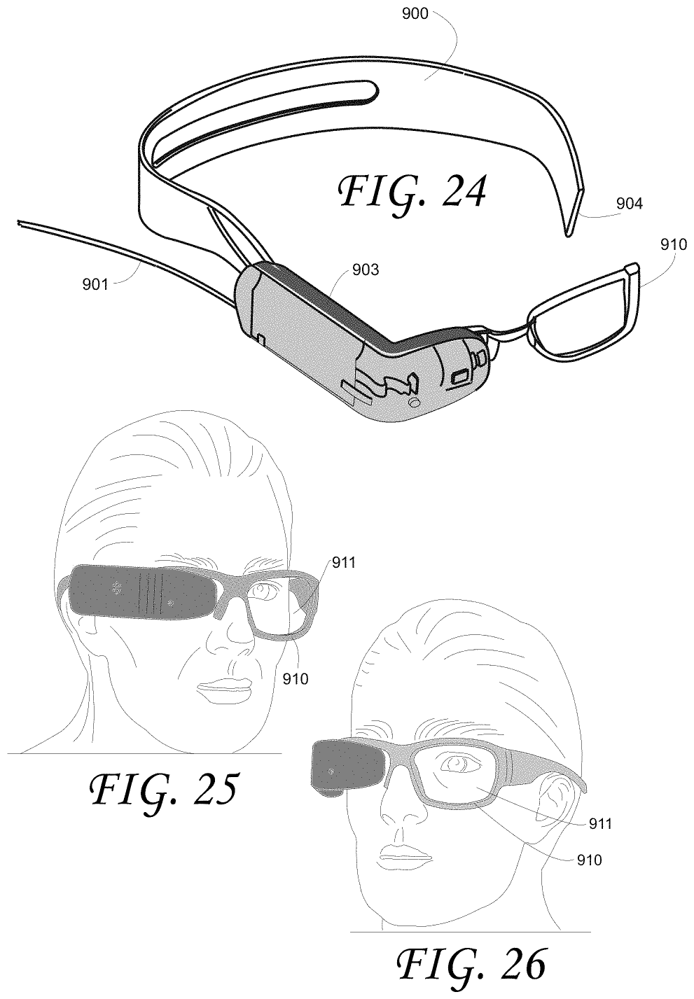

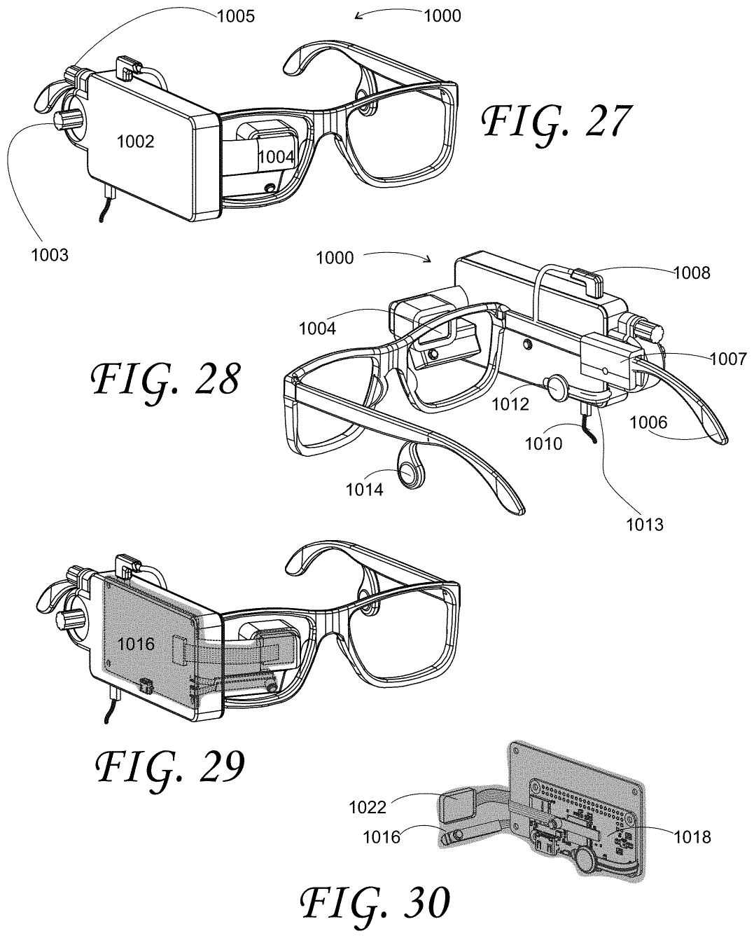

FIG. 27 is a front view of another version of the monitor which has many of the features of other monitors disclosed herein and the same or similar functionality. In this embodiment, shown generally at 1000, the electronics are contained in a housing 1002 and a display is shown at 1004. Knobs 1003 and 1005 are used to clamp the housing of the electronics and display assembly at a desired orientation and to permit rotation about lateral and vertical axes. For example, the knobs 1003, 1005 can be configured such that rotation of each knob 1003, 1005 causes a change in the distance between the housing 1002 and the frame. This allows the test-taker to adjust the display 1004 to properly align the display with the test-taker's eye. The housing 1002 and the display 1004 thereof are therefore adjustable in position relative to the eyeglasses frame. Any adjustment mechanism to provide for this variable position may be used, with the knobs 1003, 1005 being only an exemplifying embodiment. This design is somewhat larger than previous designs as essentially all the required electronics are contained in the housing.

FIG. 28 is a view of the monitor 1000 from the rear showing a glasses frame 1006 and adjustable clamping mechanism 1007 for attaching the housing containing the electronics to a temple of the glasses frame 1006. Clamping mechanism 1007 includes the two knobs 1003, 1005 that provide for the adjustment of housing portion relative to the glasses frame 1006. The clamping mechanism 1007 is clamped to the glasses frame by tightening screw 1011 which allows the entire assembly to be positioned relative to the glasses frame.

Power is supplied to the monitor 1000, e.g., through wire 1010. A contact microphone 1012 is provided and presses against the skin of the test-taker by means of spring 1013 connected to housing 1002. Spring 1013 extends from the housing 1002 inward, i.e., toward the opposite temple. The contact microphone 1012 is arranged proximate or at an inward end of the spring 1013 and is biased to be further outward from the temple so that when the monitor 1000 is worn, the spring 1013 may be compressed and thus exerts a force against the skin of the wearer thereby maintaining contact between the contact microphone 1012 and the skin of the wearer or test-taker. A sound generator, such as a contact speaker 1014, is provided on the other temple of the glasses frame 1006. Microphone 1012 and speaker 1014 are in electronic communications with the processor in housing 1002 to operate as disclosed above. The contact speaker, also called a bone speaker, emits an audible sound as well as a vibration to the skin and/or bone of the test taker. This audible sound can be used to test the audio microphone 24 replacing sound creator 28.

The test-taker is generally forbidden from talking during the test, to prevent the test-taker from orally supplying test questions to an accomplice. The microphone 24 could be used for monitoring the test taker's talking, however, other sounds in the environment would also be recorded by such a microphone and it may be difficult to differentiate the communication by the test-taker from sounds that might be in the environment. A contact microphone will only detect sound vibrations coming through the skin of the test-taker and substantially ignore all other sounds. Therefore, it is a preferred method of determining whether the test-taker is talking. For this system to work, the contact microphone 1012 must be in contact with the skin of the test-taker. Various techniques can be used to determine that this contact is taking place such as an optical sensor that looks for the skin of the test-taker, a capacitive sensor that determines the capacitance of the skin, a temperature sensor that measures the skin temperature among others. Each of these methods can potentially be defeated through such techniques as placing a sound-blocking material between the contact microphone and the skin such that the material does not interfere with the optical, capacitance or temperature sensors.

To address this issue, the contact speaker 1014 can be placed on the opposite side of the test-taker's head. Contact speaker 1014 can be programmed to periodically transmit a sound through the head of the test-taker to the contact microphone 1012 and to the audio microphone 24. If both contact devices are in contact with the skin of the test-taker, the transmission will be detected by the contact microphone 1014 thereby confirming that the monitor 1000 is properly in place.

The bone or contact microphone should be activated with voice recognition whenever it hears anything. The audio microphone should be activated whenever there is a transmission from the audio speaker and when it hears talking. If the test-taker finds a way to defeat the contact microphone and talks, the audio microphone should pick it up. If the environment is too noisy then the test can be paused until the noise quiets down. The test-taker should not be taking a test in an environment where there is excessive talking.

Prior to the start of a test, the test-taker can be asked to state his name and both microphones should be able to record this. If there is any doubt about the activation of the bone microphone, or at other random times, the test can ask the test-taker to restate his name or some other announcement. Both microphones should register the response without an unreasonable delay. In a later version it may be desirable to have more than one microphone in the headset so that the location of the sound source can be triangulated. Some triangulation can occur even with the two microphones described here.

FIG. 29 illustrates use of chassis intrusion detector, CID, 1016, like CID 22 described above or any other CID disclosed herein, with this design. FIG. 30 additionally shows electronics 1018 from an inside view that is covered by CID 1016. Display 1022 is similarly covered by the CID 1016.

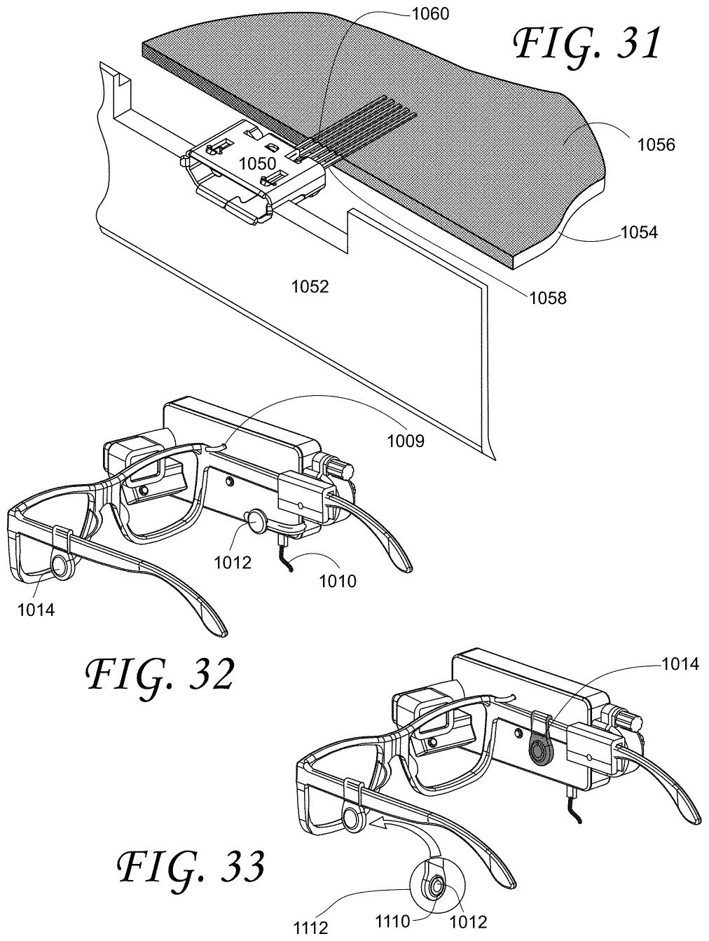

FIG. 31 illustrates an exemplifying method of attaching a USB connector for supplying power to a monitor through a CID 1056 or CID 22 or any other CID disclosed herein. CID 1056 is shown covering a portion of a PC board 1054. A USB connector 1050 is attached to housing 1052. USB connector pins 1058 pass through small holes 1060 provided in the CID 1056. These holes 1060 are sufficiently small that it would be very difficult for anyone to defeat the CID 1056 through these holes 1060. The illustrated monitor may be any of the monitors disclosed herein.

FIG. 32 is a view like FIG. 28 showing the contact speaker 1014 and contact microphone 1012. Contact speaker 1014 has been moved forward on the temple of the glasses frame 1006 in order to accommodate bearded test-takers. A movable connection of the contact speaker 1014 to the temple is provided. The connection from the speaker 1014 to the electronics is through wire 1009 that may pass through an interior space in the temple and lens portion. Wire 1010 goes from the USB connector described in FIG. 31 to a source of power such as a wall outlet.

FIG. 33 illustrates the addition of an EKG sensor in the form of a thin film 1110 which is placed on top of the contact microphone 1012 (to form a microphone assembly) and the contact speaker 1014 (to form a speaker assembly). In FIG. 33, both the contact microphone 1012 and contact speaker 1014, with EKG sensors, are moved forward on the temples of the glasses frame 1006 so that they contact skin of bearded people. Note that the contact microphone 1014 is covered with the CID whereas the contact speaker 1012 is not. Both devices could be covered with CIDs but it may not be necessary to cover the contact speaker.

The EKG sensors, also known as electrocardiogram sensors or ECG sensors, allow for the measurement of the heartbeat shape and serves as a further verification that the contact speaker and microphone are in contact with the skin. An EKG also provides an alternate biometric verification of the identity of the test-taker. Since the signal levels for EKG measurements are very low, the sensor pads cannot be covered by the CID. This issue can be resolved by allowing two conductors to be placed through the CID allowing the EKG pads to be glued to the outside of the CID. The remainder of the contact microphone can be placed inside the CID cover.

Alternate Head Mounting Systems

FIG. 24 is an alternate frame design which can include a plastic or metal headband 900 connected to a housing 903 (like housing 21), and it can be also be in the form of elastic band for better fixing the device on the test-taker's head, i.e., end 904 is connected to the glasses 910 (not shown). A USB cable connected to the device is shown as 901 in FIG. 24.

FIGS. 25 and 26 show another variant of glasses rim 910. A see-through lens as with ordinary vision correction glasses is shown as 911, but the device can be without such a glass lens.

16. AR and Teaching Non-Educational Applications

Any of various capabilities can be incorporated into several of the monitor designs disclosed herein. Several of these will now be described.

In order to prevent any leakage of information from the combiner upon which the test-taker views the test to the outside world, the lens through which the user views the surrounding environment can incorporate a Kerr or Pockets cell or an electrochromic or liquid crystal film which turns dark, for example, when the test is underway. The same apparatus can be used to control the relative brightness of the room or ambient light relative to the display to enhance the display contrast.

An IMU can be added where the knowledge of the kinematic or rotational motion of the head of the test-taker is desirable. Such a device can be used, for example, to register head motions for the control of various functions depending on the programs present and running on the monitor CPU. A GPS can be added where it is desirable to know the location of the monitor. The GPS and IMU can work with the various cameras to map the environment where the monitor is in use which can permit the placement of augmented devices as in augmented reality. Additionally, the display can be pinned to the environment allowing, for example, the use of multiple screen images where the user can move from screen to screen merely by moving his or her head as if the room where the test-taker is situated had multiple TV screens. A magnetometer can additionally be added to help orient the monitor.

Although the patent literature on smartglasses provides examples of the use of lidar to map the environment, for example the room where the test-taker is situated, a preferred mapping system can use the techniques disclosed in US Pat. Appln. No. 20190271550 for road mapping. The monitor has one or more cameras and the head of the test-taker is frequently moving allowing, in conjunction with the IMU, GPS and other related apparatus, the accurately mapping of the environment using stereographic techniques as disclosed in the '550 publication. A magnetic compass or magnetometer can also be included in the monitor to aid in the orientation or mapping process.

The test-taker can use a laser pointer to allow selection of a point in the surrounding environment. This can be used in conjunction with augmented reality to locate a particular point where the augmented reality device should appear. This laser pointer can be augmented with lidar capabilities to allow, on a limited basis, the determination of the distance to the object that is being selected. See, for example, U.S. Pat. No. 10,152,141.

In addition to cameras and lidar, structured light can also be used to map the geometry in the surrounding area relative to the monitor. In this case, patterned light beams can be sent from, for example, different sides of the monitor and the interference or relative position of these structured patterns can determine the distance from the monitor. See, for example, U.S. Pat. No. 7,182,465.

A 360-degree camera can be mounted onto the top of the monitor through using a separate strap which provides the capability of monitoring and photographing the entire space surrounding the test-taker. Alternately, cameras can be mounted to the sides and rear of the monitor to get a 360-degree view of the environment surrounding the test-taker.

The iris camera can be used to sense the blink of an eye which can additionally be used to control the display or other features or capabilities of the monitor. In addition to typing on a virtual keyboard or operating a virtual mouse, motions of the hands and fingers can be used as gestures to control monitor displays or other functions as discussed above.

One way to add a functioning keyboard to the monitor is by a virtual keyboard. This virtual keyboard can be displayed in the field of view of the test-taker as can be his hands relative to the keyboard. By watching the test-taker typing the characters that are intended to be depressed, this can be recorded and converted to characters on the display. Alternatively, a physical keyboard can be used; however, this poses some unique problems. The keyboard must not have the capability of transmitting data to any place other than the monitor. If it can do so, then the keyboard can be used to type questions to a consultant. A keyboard can be designed with a hidden switch, or a defined key, which sends a wireless signal to the consultant which is not registered by the monitor. If the monitor determines that the test-taker is typing but it is not receiving the result of that typing, then the test can be terminated. Alternatively, the keyboard can be covered with a CID and can communicate to the monitor using encryption. A virtual keyboard may be picked up by an infrastructure mounted camera, although this would be difficult and easily defeated by moving the keyboard slightly.

Additional sensors can be mounted on the monitor to monitor the health state of the test-taker, for example, a heart rate monitor, a temperature sensor and an EEC are three possibilities. Some versions of the monitor have an EKG (ECG) sensor which can be used for biometric identification as well as health monitoring as discussed above.

An ambient light sensor can be added to aid in the control of the various cameras. A capacitance sensor or microscope lens can also be added to determine contact with the skin by the contact microphone. As mentioned above, a blood flow sensor can also be used for that purpose as well as a skin temperature sensor. Additionally, a picture of the face skin can be used to measure the distance to the skin by having a very small depth of field or by using structured light or just a laser shined at an oblique angle.

An endfire microphone array, or similar device, can also be used in order to determine the direction of incoming sound. This can augment the contact microphone for determining when the test-taker is speaking or otherwise creating sounds. Other combinations of multiple microphones can be used to localize source of speech. An earbud, for example, can include additional sensors such as a microphone or array of microphones. In some embodiments, at least two microphones from a microphone array can be arranged along a line pointed towards or at least near the mouth of a user. By using information received by the orientation sensor or sensors, a controller within the earbud, or other device, can determine which microphones of a microphone array should be activated to obtain this configuration. By activating only those microphones arranged along a vector pointed at or near the mouth, ambient audio signals not originating near the mouth can be ignored by applying a spatial filtering process.

Ultrasonic, IR, RF, and similar sensors can be added if the need arises. Tactile or touch sensors can be added to allow for finger control of the monitor. Such sensors are used on Google Glass for example.

Systems are under development to allow direct communication from a person's brain to a device separate from the body. The concept is to allow for direct brain to Internet communication. Such a system could be used to defeat the cheating prevention systems described herein and therefore a device can be added to the monitor to sense for such communications when that technology becomes available.

Various hand mounted sensors, including a camera, RF transmitter, and LED, can also be used to control monitor functions.

17. Locking the Display to Location

An advantage in locking the display view to a physical location is that the view can be changed by the test-taker simply moving his or her head. For example, depending on the size of available memory, multiple screens can be available containing multiple websites or TV stations and the test-taker can switch between them merely by head movements. By using the monitor design of FIGS. 44A-44I, for example, each screen can be equivalent to a large screen TV. Sound that accompanies each screen can be controlled since the monitor will know which screen is being observed by the test-taker.

18. Education

Although the descriptions and examples used herein have been primarily focused on test taking, the same monitors can be used for education. Using the large displays of FIGS. 44A-44I, MOOCs or other educational classes can be watched by students. After taking a MOOC course, for example, the student can immediately take a secure test for credit.

19. Textbooks

It has been demonstrated that a textbook can be written by a computer program. The raw information for creating textbooks for most courses is available for free in the Internet. A curator can be established for each course and after the computer program has created a draft textbook, the curator can review it to eliminate any errors. For those fields where the knowledge base is changing rapidly, a computer-generated text can keep up and the students will have the latest information without waiting of a year or so for a new textbook to be published as in the case now.

20. Business Methods

If the textbooks become standardized and the tests covering those textbooks also become standardized, an entire course leading to degrees can be created that have the highest level and integrity. Many opportunities will arise to disrupt education based on the teachings disclosed herein.

21. Software

Various software modules that can be resident in the Monitor include:
a. Iris capture
b. Eyeball location
c. EKG capture and biometric recognition
d. Finger and hand recognition and monitoring
e. Voice recognition biometric
f. Sounds emanating from the test-taker's mouth
g. Nefarious object presence recognition in iris or cross view camera images.
h. Cryptographic key set determination from an iris code.
i. CID broken wire detection
j. School registration software

Various software modules that can be resident on the server which interacts with the monitor include:
a. Communication with universities or other test suppliers
b. Test reception, scrambling and encryption
c. Iris and other pattern recognition
d. Communication with monitors

22. Summary

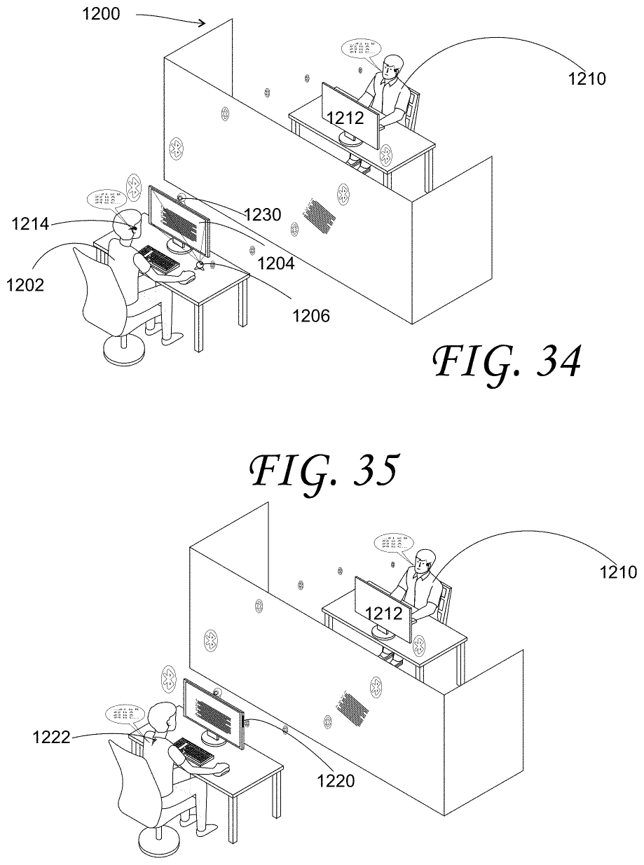

A key feature of this device is that it makes cheating almost impossible. FIG. 34 illustrates a method of cheating that would be available for remote-proctored exams where the proctor monitors the test-taker through a camera mounted on the test-taker's computer 1230. In FIG. 34, the test-taker 1202 has placed a camera 1206 on his table where it has a view of the display 1204 but is not observable from the proctor's camera 1230. Camera 1206 can wirelessly transmit images of the test to an accomplice 1210 remote from the room where the test is being taken. The accomplice 1210 can see the test on his display 1212 and wirelessly transmit the answers to an ear-mounted receiver 1214 worn by the test-taker 1202. The accomplice 1210 therefore can provide answers to the test-taker in a manner that cannot be detected by the proctor.

FIG. 39 represents the growth of the student test assistance industry. As more and more students begin taking tests online, more test providers will opt for using proctoring services 1460 in as attempt to stem the tide of cheating. Since it is not possible to secure the computer on which the student is taking the test, a call center industry 1450 devoted to aiding students desiring to cheat will spring up in the same manner that term paper writing companies have become established. The content of the test will be passed electronically to the accomplice at the cheating enabling call center 1450 who will pass the answers to the test-taker electronically perhaps through a contact microphone affixed to the test-taker's shoulder bone. Since this will not be perceivable by the proctors 1460, cheating will be successful and the cheating call center industry will thrive.

In addition to a direct connection to the test-taker's computer, screen viewing cameras are easily installed that cannot be seen by a proctor. There are many other methods of placing a camera which cannot be observed by a proctor. These include mounting a camera on the wall of the room where the test is taking place but out of view of the proctor's camera. Some proctors require that the test-taker rotate the camera around the room prior to taking the tests so that the proctor can see whether there are such cameras placed where they can see the test. In such cases, tiny cameras can be mounted on a wall or even the clothes of the test-taker which are unobservable, due to their minute size, by the proctor. The proctor may observe something strange in the ear of the test-taker in which case, a more sophisticated approach is shown in FIG. 35.

In this situation, a contact speaker 1222 is hidden underneath the clothes of the test-taker and to make the situation even more difficult, the test-taker's computer has been modified to include a Bluetooth transmitter 1220 which is capable of transmitting contents of the test to an accomplice 1210 in another room.

An objective of the test-taking system of this invention is that it is completely automatic without requiring intervention of any human other than the test-taker. The institution administering the test will have a limited set of rules which, if violated, will render the test invalid. These rules can be general rules or rules specific to the test being taken. These rules can include: the event(s) which will invalidate a test; the number of times that the test, once an event has occurred, can be restarted if any; the number of times that a particular test can be taken if failed; the time permitted to take the test; the number and length of pauses permitted during the test-taking process; etc. Some or all of the rules may or may not be communicated to the test-taker.

This puts a small burden on the institution to determine what constitutes cheating and the consequences. This is a relatively light burden with the test-taking apparatus of this invention, the Monitor, since once the rules have been set the opportunities for an undetected violation of these rules are very limited or nonexistent.

A substantial number of sensors have been introduced, each of these sensors requires at least one algorithm to assess sensor output and determine whether the test-taker is cheating or not. Since the Monitor is provided with a chassis intrusion detector (CID), it is virtually impossible for a consultant to modify the apparatus to transmit the display information to another room, for example. With a CID, there are no accessible wires which connect the display to the electronics package, for example.

Finally, the display itself is protected. The test-taker can wear a camera which has a lens the size of a small pea but for that camera to see the display, it will also be seen by the iris imager or the eye-to-display crossview cameras since there is a very limited viewing area for the camera to see the display.

Of course, if a cheating method is discovered, it will quickly become public through the Internet, defeating the Monitor solution. Therefore, a continuous improvement process, which rewards test-takers who discover cheating methods, can be implemented.

At the discretion of the institution, a time limit or no time limit can be afforded the test-taker for completing the test. Similarly, a course can have only a single final exam or a series of quizzes in addition to a midterm and final exam or feedback can be requested from the test-taker during each course session depending on the course and the desires of the institution. Since all such tests will be graded automatically, the cost of having daily or more frequent quizzes versus a single final exam is insignificant. In one extreme case, all the required courses can be given without any exams and a final comprehensive exam can be used to validate a student for receiving a degree. Alternately, the student can be tested continuously during the course or degree process without any final examinations. These decisions are left up to the institution. These options are facilitated due to the ability of the test-taker to observe instructions presented on the computer or Monitor screen and at arbitrary times be tested using the Monitor.

The test-taker can enter data into the testing program through the keyboard 708 (FIG. 18), a track pad (not shown), and/or the mouse 707, or any other type of user interface such as a touch screen of a laptop computer or smartphone 705 (see FIG. 17) when the device is connected thereto. The mouse 707 or keyboard 708 can be attached to a smartphone or computer 710 with a fixed wire or wirelessly. Test questions, however, will only be displayed on the Monitor display.

The test is preferably configured such that the answers do not provide information relative to the question. Therefore, someone viewing the answers cannot discern therefrom the questions. Therefore, the question answers do not need to be encrypted but can be sent in an unencrypted form to the test providing institution. However, for reasons discussed elsewhere herein, the test answers will in general be encrypted and, in some cases, with the server and again with the test provider public keys.

For example, if the test providing institution is providing tests to 1000 students either simultaneously or at different times, and if the test is of a multiple-choice type and contains 50 questions, the order of the questions will be different for each test provided. Since this provides a very large number of different tests each containing the same questions, there is little risk that answers from one set of questions can be of any value to a student taking a different ordered set of the same questions.

Some important features of this invention differentiate it significantly from prior art attempts to develop secure testing systems. These include:
1. Use of a head-mounted display for presenting randomized questions to the test-taker in a manner that questions cannot be obtained or observed by another person. Such a display can be in the form of a small light emitting display held near the eye of the test-taker or larger displays reflected off of a combiner.
2. The same test is given to multiple test-takers wherein the order of the test questions is randomized to prevent passing of answers from one test-taker to another. Each test-taker can take the identical test but the questions are ordered differently.
3. The test-taking process is fully automatic and does not require human intervention. If the test-taker violates rules of the institution, the violation will be noted and provided to the test-taker. The institution will only get involved if the test-taker protests the results.
4. No video or audio data is, in general, forwarded to the test-taking institution. If the test was successfully completed, it is assumed that no cheating occurred. If the test is interrupted, diagnostic information can be retained and upon request of the institution, forwarded thereto for diagnostic purposes. In general, neither video nor audio information is stored during the test-taking process unless the test is interrupted.
5. No behavioral measurements are made, recorded, or sent to the institution and thus it is not necessary to try to interpret cheating activity based on behavioral or other measurements.
6. Test questions are only available to the display which are part of the inventive device (the Monitor) and protected using strong encryption and by the chassis intrusion detecting system.
7. Since it is virtually impossible for a consultant to observe a copy of the test, attempts to determine that a consultant is communicating with the test-taker other than by oral communications are unnecessary. Such communications from the consultant are impossible to reliably detect. Oral communications from the test-taker are forbidden and if detected by a contact microphone, for example, the test can be stopped.
8. The test encryption and decryption key set can be created by the inventive device using a secret algorithm based on the iris code determined by the server. At the end of the test, the private key is destroyed. Since the only copy that exists is on the monitor and protected by the chassis intrusion detector, no other device can decrypt the test which has been created by the test-providing institution uniquely for the monitor. In an alternate system, the private key is permanently resident on the Monitor and associated with the test-taker only for the duration of the test.
9. Use of sophisticated neural network-based pattern recognition algorithms allow for continuous improvement of this system if and when new cheating methods are discovered. This allows for upgrading software of the system as new improvements are implemented.

In addition to multiple choice test, any of the monitors disclosed herein may be used for tests that require written answers. For such tests, the monitor is equipped preferably with a high definition display permitting multiple lines of text to be displayed. The monitor should also be capable of displaying a virtual keyboard permitting the test-taker to type on a desk or table, for example, which will be observed by the forward-facing camera. Such a virtual keyboard is described in U.S. Pat. No. 10,180,572. When provided with a question requiring a text response, the test-taker will use the virtual keyboard on the display to type the answer which will then appear on the display. In this manner, a response by the test-taker cannot be observed by an associate looking over his shoulder while the test is being taken. In some implementations, a physical keyboard can be provided as discussed above.

In some cases, a written response to a test will be required especially when a mathematical derivation or the hand writing of mathematical expressions is required. In such a case, the test-taker can be provided with a tablet onto which his hand-written response will be entered. The tablet will not show the test-taker's handwriting but will be linked to the monitor in such a manner that only the monitor receives the hand-written response. This response will be displayed on to the display for review and correction by the test taker.

Instead of using a Kerr or Pockets cell to black out a forward part of the display to prevent observance of the display through the glasses by an accomplice, electrochromic glass or film on plastic can be used for this function, as described in U.S. Pat. No. 10,180,572. In this case, the electrochromic glass will be turned totally black or opaque by a control mechanism so that the contents of the display cannot be seen from a person standing in front of the test-taker. Another approach is to use polarized lenses for the glasses and for the display where the angle of polarization is rotated 90 degrees. For example, the glasses can be vertically polarized and the display horizontally polarized. In this case, light from the display will not pass through the glasses preventing it from being observed by an accomplice standing in front of the test-taker.

Using the EKG system disclosed herein, an equipped monitor obtains a second biometric system for identifying the test-taker and for verifying that the test-taker is in fact wearing the monitor. Thus, in addition to the iris biometric, obtained by the iris camera, the EKG pads on opposite sides of the test-taker's head will record the shape of the heartbeat of the test-taker which is unique to that test-taker and thus is a biometric identifier of the test-taker.

In addition to using the mouse, the test-taker can use his voice to enter commands to the monitor. Although this could be used as an alternative to the mouse described above for answering test questions, it can also be used for other commands such as initiating the test or controlling the display of the test questions for example. The test-taker can say “next question”, “I need a break”, “test finished” etc. The contact microphone will pick up the words spoken by the test-taker and thus can perform the various commands. Voice entry can also be used for answering essay type questions where it is obvious that the test-taker is not using his voice to request help from an accomplice. In a version of the monitor, tiny microphones can be provided which are inserted into the ears of the test-taker in order to hear if the test-taker is using a speaker inserted into his ear. Such a speaker would be like a hearing aid. Such microphones can be tiny devices measuring no more than a cubic millimeter. They can be inserted into the test-taker's ear when the test-taker is wearing the monitor. Such microphones will also pick up the voice of the test-taker and therefore on command of the monitor that test-taker can say something to test that the in-ear microphones are properly installed. Talking can also be used to test operation of the contact microphone, although, as described above, other tests based on the contact speaker and the EKG devices are provided for this function.

Scrambling of the order of the test questions is described above. Additionally, multiple-choice answers to the test questions can be similarly scrambled.

Other methods can be used with the monitor to permit the test-taker to enter commands to the monitor. One such method using the iris camera is track the motion of the eye which is usable to select answers to the questions or to control the operation of the monitor. Eye blinking and time or duration of closing also can be used for this purpose. Another such method is to use gestures which can be seen by the forward-facing camera and interpreted by appropriate software. Teeth clicking, for example, can be used for controlling the test and in particular for choosing various of the multiple choices for a test question.

The lenses of the glasses can be made easily replaceable permitting different prescription lenses to be used for different test-takers.

Disclosed herein are a series of measures that are designed to prevent transfer of test-related information to anyone other than the test-taker by any means either visually, electronically, or wirelessly. Measures disclosed herein are not exhaustive and the intent of this invention is to cover preferred implementations of such techniques. Similarly, disclosed herein are a series of measures to prevent information from being transmitted to a test-taker on the assumption that the information about the test has leaked to a consultant. Since the consultant now must transmit to the test-taker information which will affect how the test-taker answers the question, this invention has also not exhaustively disclosed all possibilities of information transfer from the consultant but only representative cases.

It is not the intent of the inventors to cover all such transfer means including, for example, haptic methods which have not been discussed above. These include, for example, a wire attached to the test-taker and physically held by the consultant who may in fact be in another room wherein the wire travels through a hole in a wall. In this case, for example, if the consultant knows the test question and has determined that the proper answer is 3 then the consultant could pull three times on the wire thereby transmitting this information to the test-taker. All sorts of similar haptic techniques exist including electrically actuated vibrators, spark creators etc. To cover all such possibilities of either the leaks of information out of the test-taking device or the communication of information to the test-taker would require volumes. Thus, it is the intent of the inventor to cover all such possibilities while disclosing those that are most readily implemented.

The devices disclosed herein are not required to be used for testing purposes and may be used for other purposes, e.g., gaming, entertainment.

Finally, all patents, patent application publications and non-patent material identified above are incorporated by reference herein. The features disclosed in this material may be used in the invention to the extent possible.

Although several preferred embodiments are illustrated and described above, there are possible combinations using other geometries, sensors, materials and different dimensions for the components that perform the same functions. At least one of the inventions disclosed herein is not limited to the above embodiments and should be determined by the following claims. There are also numerous additional applications in addition to those described above. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention which is limited only by the following claims.

1. A system, comprising:
a frame having a front and a rear and being configured to be secured on or against a head of a person's head with the rear closer to the person's head;
a display on said frame and that operatively displays content thereon; and
a combiner on said frame,
said combiner having an upper edge portion adjacent the front of said frame and a lower edge portion below said upper edge portion, said combiner being angled away from said frame in a rearward direction away from the front of said frame,
said combiner being configured to allow for viewing of said combiner by a person, whose eyes are on one side of said combiner, an environment on an opposite side of said combiner and thus viewing of the environment through said combiner, and for viewing of content being reflected onto said combiner;
said combiner including an at least partially reflective surface positioned below said display to cause formation of an optical path downward from said display to said at least partially reflective surface of said combiner and rearward from said at least partially reflective surface of said combiner to the right and left eyes of the person when said frame is on the person's head, said at least partially reflective surface having a state in which it reflects content of said display, when present, to at least one of the person's eyes when said frame is on the person's head while allowing viewing by the person of an environment in front of the person through said at least partially reflective surface such that the person simultaneously views, through said at least partially reflective surface, content on said display being reflected by said at least partially reflective surface of said combiner and the environment in front of the person.

2. The system of claim 1, wherein said display comprises first and second portions positioned horizontally alongside one another, said combiner reflecting content of said first portion of said display, when present, to the person's left eye when said frame is on the person's head and reflecting content of said second portion of said display, when present, to the person's right eye when said frame is on the person's head.

3. The system of claim 1, wherein said combiner is spaced from said display such that the optical path is formed through a space below said frame and in front of said combiner and said at least partially reflective surface is formed by a semi-reflective coating on an inside surface in the optical path between said display and the person's eyes when said frame is on the person's head, and said combiner is positioned in front of the person's eyes when said frame is on the person's head to allow viewing of the environment in front of the person through said combiner when said frame is on the person's head, and
said combiner includes an antireflective coating on an outside surface to allow light from the environment to pass through said combiner from the environment.

4. The system of claim 1, further comprising a forehead resting pad arranged at the front of said frame in a position to contact a forehead of the person when said frame is on the person's head.

5. The system of claim 1, wherein said frame comprises:
a front portion including said display, and said combiner; and
a first elongate band having first and second opposite ends and being coupled at said first and second ends to said front portion.

6. The system of claim 5, wherein said frame further comprises:
a second elongate band adjacent said front portion and which is in contact with skin of the person when said frame is on the person's head;
a contact microphone that detects sound emitted by the person when said frame is on the person's head; and
a contact speaker spaced apart from said contact microphone and that is used to check if said contact microphone is against the person's head when said frame is on the person's head.

7. The system of claim 5, further comprising a chassis intrusion detector system arranged over said front portion.

8. The system of claim 1, further comprising:
a presence and/or position-determining camera system on said frame and that images an area rearward of said combiner in which the head of the person will be situated;
a forward-looking camera system arranged on said frame and that images an area in front of said frame; and
a processing system coupled to said presence and/or position-determining camera system and said forward-looking camera system and that:
analyzes images obtained by said presence and/or position-determining camera system to determine presence of imaging devices in any obtained images and/or position of an iris of each of the at least one left and right eye of the person on which said frame is situated; and
analyzes images obtained by said forward-looking camera system to determine presence of specific objects.

9. The system of claim 8, wherein said processing system comprises at least one processor separate and apart from said frame.

10. The system of claim 8, wherein said presence and/or position-determining camera system comprises:
a first crossview camera on a first lateral side of said frame and that images inward of said first lateral side of said frame toward a second lateral side of said frame opposite said first lateral side of said frame and below said combiner; and
a second crossview camera on said second lateral side of said frame and that images inward of said second lateral side of said frame toward said first lateral side of said frame and below said combiner.

11. The system of claim 8, wherein said presence and/or position-determining camera system comprises:
a first iris camera on said frame to image the left eye of the person on which said frame is situated; and
a second iris camera on said frame to image the right eye of the person on which said frame is situated.

12. The system of claim 11, wherein said processing system further analyzes images obtained by said first and second iris cameras and performs a biometric identification, based on the image analysis and previously obtained biometric data, and analyzes images obtained by said first and second iris cameras to determine presence of imaging devices in any obtained images.

13. The system of claim 8, wherein said processing system uses pattern recognition when analyzing images obtained by said presence and/or position-determining camera system to determine presence of imaging devices in any obtained images and/or to determine position of irises of the person on which said frame is situated, and when analyzing images obtained by said forward-looking camera system to determine presence of specific objects.

14. A method for conducting a test, comprising:
providing a monitor to a test-taker, the monitor including a frame, a display on the frame and that operatively displays content thereon, and a combiner on the frame, the combiner being configured to allow for viewing of the combiner by the test-taker, whose eyes are on one side of the combiner, an environment on an opposite side of the combiner and thus viewing of the environment through the combiner, and for viewing of content being reflected onto the combiner;
conducting a test of the test-taker by causing display of test questions on the display which are reflected to the combiner and then visible to the test-taker;
imaging an area rearward of the combiner using a presence and/or position-determining camera system;
imaging an area in front of the frame using a forward-looking camera system;
analyzing, using a processing system at least partly separate and apart from the frame, images obtained by the presence and/or position-determining camera system to determine presence of imaging devices in any obtained images and/or position of an iris of each of the at least one left and right eye of the person on which the frame is situated;
analyzing, using the processing system, images obtained by the forward-looking camera system to determine presence of cheat-aiding objects; and
stopping conducting of the test when imaging devices are determined to be present in any obtained images, when the position of an iris of each of the at least one left and right eye of the person changes or when a cheat-aiding object is determined to be present.

15. The method of claim 14, wherein the step of analyzing, using a processing system at least partly separate and apart from the frame, images obtained by the presence and/or position-determining camera system to determine presence of imaging devices in any obtained images and/or position of an iris of each of the at least one left and right eye of the person on which the frame is situated comprises transmitting the images to the cloud and performing the image processing in the cloud.

16. The method of claim 14, wherein the step of analyzing, using a processing system at least partly separate and apart from the frame, images obtained by the presence and/or position-determining camera system to determine presence of imaging devices in any obtained images and/or position of an iris of each of the at least one left and right eye of the person on which the frame is situated comprises using pattern recognition to analyze the images.

17. The method of claim 14, further comprising situating the presence and/or position-determining camera system and the forward-looking camera system on the frame.

18. The method of claim 14, wherein the frame has a front and a rear, further comprising securing the frame on or against the test-taker's head with the rear closer to the person's head, the combiner having an upper edge portion adjacent the front of the frame and a lower edge portion below the upper edge portion and being angled away from the frame in a rearward direction away from the front of the frame.

19. The method of claim 14, further comprising configuring the combiner to allow for viewing of the combiner by the test-taker, whose eyes are on one side of the combiner, an environment on an opposite side of the combiner and thus viewing of the environment through the combiner, and for viewing of content being reflected onto the combiner.

20. The system of claim 14, further comprising providing the combiner with an at least partially reflective surface below the display to cause formation of an optical path downward from the display to the at least partially reflective surface of the combiner and rearward from the at least partially reflective surface of the combiner to the right and left eyes of the test-taker when the frame is on the test-taker's head, the at least partially reflective surface having a state in which it reflects content of the display, when present, to at least one of the test-taker's eyes when the frame is on the person's head while allowing viewing by the test-taker of an environment in front of the test-taker through the at least partially reflective surface such that the test-taker simultaneously views, through the at least partially reflective surface, content on the display being reflected by the at least partially reflective surface of the combiner and the environment in front of the test-taker.
